(19) United States
(12) Patent Application Publication
(10) Pub. No.: US 2025/0199215 A1
(43) Pub. Date: Jun. 19, 2025

(54) OPTICAL FILTER

(71) Applicant: AGC Inc., Tokyo (JP)

(72) Inventors: Kazuhiko SHIONO, Fukushima (JP); Takashi NAGATA, Shizuoka (JP)

(73) Assignee: AGC Inc., Tokyo (JP)

(21) Appl. No.: 18/967,757

(22) Filed: Dec. 4, 2024

(30) Foreign Application Priority Data
Dec. 13, 2023 (JP) 2023-210429

(51) Int. Cl. G02B 5/20; G02B 1/111

(52) U.S. Cl. CPC G02B 5/208; G02B 1/111

(57) ABSTRACT

An optical filter includes: a dielectric multilayer film 1; a glass substrate; a dielectric multilayer film 2; a light-absorbing layer; and a dielectric multilayer film 3 in this order, in which the light-absorbing layer comprises a near-infrared ray absorbing dye, and the optical filter satisfies all of spectral characteristics (i-1) to (i-6).

### CROSS-REFERENCE TO RELATED APPLICATIONS

This application claims priority from Japanese Patent Application No. 2023-210429 filed on Dec. 13, 2023, the entire subject matter of which is incorporated herein by reference.

### TECHNICAL FIELD

The present invention relates to an optical filter.

### BACKGROUND ART

For an imaging device including a solid state image sensor, an application thereof is extended to a device that takes an image anytime during day and night, such as a monitoring camera or an in-vehicle camera. In such a device, it is necessary to acquire (color) images based on visible light and (monochrome) images based on infrared light.

Therefore, there has been studied use of an optical filter having, in addition to a near-infrared ray cut filter function for transmitting visible light and correctly reproducing an image based on the visible light, a function of selectively transmitting specific near-infrared light, that is, a dual band pass filter.

Patent Literature 1 discloses an optical filter in which a dielectric multilayer film and a resin substrate containing a near-infrared ray absorbing dye are combined, and near-infrared light around 850 nm and visible light are transmitted and other light is shielded.

Patent Literature 2 discloses an optical filter in which a dielectric multilayer film and a resin substrate containing a near-infrared ray absorbing dye are combined, and near-infrared light around 940 nm and visible light are transmitted and other light is shielded.

### CITATION LIST

### Patent Literature

Patent Literature 1: WO2017-030174
Patent Literature 2: JP2016-200771A

### SUMMARY OF INVENTION

In recent years, with a diversification of sensing regions in the field of imaging, laser light including a partial near-infrared light region of 1,000 nm or more, of which a wavelength region is different from those in Patent Literatures 1 and 2, is used. Accordingly, there is a demand for an optical filter capable of transmitting near-infrared light in such sensing regions and shielding other near-infrared light and near ultraviolet light which become noises.

In an optical filter including a dielectric multilayer film, since an optical film thickness of the dielectric multilayer film changes depending on an incident angle of light, there is such a problem that a spectral transmittance curve changes depending on the incident angle. For example, as the incident angle of light increases, reflection characteristics shift to a short wavelength side, and as a result, the reflection characteristics may deteriorate in a region to be originally shielded. Such a phenomenon is likely to occur more strongly as the incident angle is larger. When such a filter is used, spectral sensitivity of the solid state image sensor may be affected by the incident angle. With a reduction in height of camera modules in recent years, use under a condition of a high incident angle is assumed, and therefore an optical filter that is hardly affected by an incident angle is required.

An object of the present invention is to provide an optical filter that is excellent in shielding properties of specific near-infrared light and near ultraviolet light, other than visible light and specific near-infrared light which become a transmission region, even at a high incident angle.

The present invention relates to an optical filter having the following configuration.

According to the present invention, an optical filter that is excellent in shielding properties of specific near-infrared light and near ultraviolet light, other than visible light and specific near-infrared light which become a transmission region, even at a high incident angle can be provided. In particular, the optical filter of the present invention is an optical filter that is excellent, even at a high incident angle, in shielding properties of near ultraviolet light, and reflection characteristics of light having a wavelength of 1,300 nm to 1,500 nm and light having a wavelength of 750 nm to 900 nm which become noise, and is hardly affected by the incident angle.

### BRIEF DESCRIPTION OF DRAWINGS

FIG. 1 is a cross-sectional view schematically illustrating an example of an optical filter according to one embodiment.

FIG. 2 is a diagram illustrating spectral transmittance curves of a glass.

FIG. 3 is a diagram illustrating a spectral transmittance curve of a light-absorbing layer.

FIG. 4 is a diagram illustrating spectral transmittance curves of an optical filter in Example 1.

FIG. 5 is a diagram illustrating spectral reflectance curves of the optical filter in Example 1.

FIG. 6 is a diagram illustrating spectral reflectance curves of the optical filter in Example 1.

FIG. 7 is a diagram illustrating spectral transmittance curves of an optical filter in Example 5.

FIG. 8 is a diagram illustrating spectral reflectance curves of the optical filter in Example 5.

FIG. 9 is a diagram illustrating spectral reflectance curves of the optical filter in Example 5.

### DESCRIPTION OF EMBODIMENTS

Hereinafter, embodiments of the present invention will be described.

In the present description, a near-infrared ray absorbing dye may be abbreviated as an “NIR dye”, and an ultraviolet absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. In addition, a group represented by the formula (I) is also referred to as a group (I), and the same applies to groups represented by other formulae.

In the present description, spectra of transmittance of a glass, a light-absorbing layer including a case where a dye is contained in a resin, transmittance measured by dissolving a dye in a solvent such as dichloromethane, transmittance of a dielectric multilayer film, and transmittance of an optical filter having the dielectric multilayer film are all “external (measured) transmittance” including reflection losses of front and back surfaces even when described as “transmittance”.

In the present description, an optical density represents a value converted from the transmittance by the following formula.

$$Optical density at wavelength of λ nm = - log 10 ( {iT}_{λ} / 100 )$$

iT_{λ}: transmittance at an incident angle of 0 degrees at the wavelength of λ nm

In the present description, transmittance of, for example, 90% or more in a specific wavelength region means that the transmittance does not fall below 90% in the entire wavelength region, that is, minimum transmittance is 90% or more in the wavelength region. Similarly, transmittance of, for example, 1% or less in a specific wavelength region means that the transmittance does not exceed 1% in the entire wavelength region, that is, maximum transmittance is 1% or less in the wavelength region. Average transmittance in the specific wavelength region is an arithmetic mean of transmittance per 1 nm in the wavelength region.

Spectral characteristics can be measured by using an ultraviolet-visible spectrophotometer.

In the present description, the symbol “-” or the word “to” that is used to express a numerical range includes the numerical values before and after the symbol or the word as the upper limit and the lower limit of the range, respectively.

### Optical Filter

An optical filter according to one embodiment of the present invention (hereinafter, also referred to as “the filter”) is an optical filter including a dielectric multilayer film 1, a glass substrate, a dielectric multilayer film 2, a light-absorbing layer, and a dielectric multilayer film 3 in this order, in which the light-absorbing layer contains a near-infrared ray absorbing dye.

Reflection characteristics of the dielectric multilayer film and absorption characteristics of the light-absorbing layer allow the optical filter as a whole to achieve excellent transmittance in a visible light region and a specific near-infrared light region, and excellent shielding properties in another near-infrared light region and a near ultraviolet region.

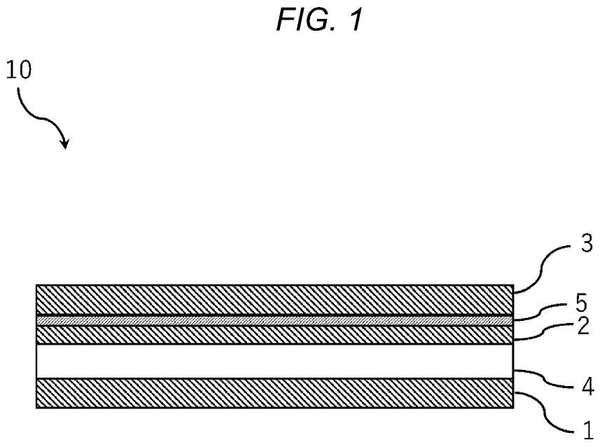

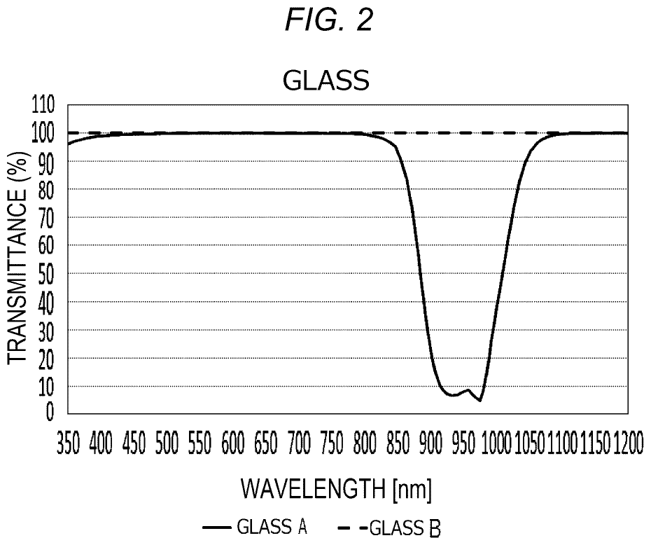

An example of a configuration of the filter will be described with reference to the drawings. FIGS. 1 and 2 are cross-sectional views schematically illustrating examples of the optical filter according to one embodiment.

An optical filter 10 illustrated in FIG. 2 is an example in which the dielectric multilayer film 1, a glass substrate 4, the dielectric multilayer film 2, a light-absorbing layer 5, and the dielectric multilayer film 3 are provided in this order.

The filter satisfies all of the following spectral characteristics (i-1) to (i-6).
(i-1) An average reflectance of a light having a wavelength of 1,300 nm to 1,500 nm when the light is incident from one main surface of the optical filter is 90% or more at an incident angle of 5 degrees and 90% or more at an incident angle of 40 degrees.
(i-2) A maximum reflectance of the light having a wavelength of 1,300 nm to 1,500 nm when the light is incident from the one main surface is 95% or more at an incident angle of 5 degrees and 95% or more at an incident angle of 40 degrees.
(i-3) An average reflectance of a light having a wavelength of 750 nm to 900 nm when the light is incident from the other main surface of the optical filter is 30% or more at an incident angle of 5 degrees and 30% or more at an incident angle of 40 degrees.
(i-4) A maximum reflectance of the light having a wavelength of 750 nm to 900 nm when the light is incident from the other main surface is 80% or more at an incident angle of 5 degrees and 70% or more at an incident angle of 40 degrees.
(i-5) An average transmittance of a light having a wavelength of 350 nm to 400 nm is 1% or less at an incident angle of 0 degrees and 2% or less at an incident angle of 40 degrees.
(i-6) A maximum transmittance of the light having a wavelength of 350 nm to 400 nm is 2% or less at an incident angle of 0 degrees and 3% or less at an incident angle of 40 degrees.

The filter satisfying all of the spectral characteristics (i-1) to (i-6) is an optical filter that is excellent, even at a high incident angle, in shielding properties of near ultraviolet light, and reflection characteristics of light having a wavelength of 1,300 nm to 1,500 nm and light having a wavelength of 750 nm to 900 nm which become noise, and is hardly affected by the incident angle.

In the spectral characteristic (i-1), the average reflectance of the light having a wavelength of 1,300 nm to 1,500 nm is preferably 94% or more at an incident angle of 5 degrees and preferably 95% or more at an incident angle of 40 degrees.

In the spectral characteristic (i-2), the maximum reflectance of the light having a wavelength of 1,300 nm to 1,500 nm is preferably 98% or more at an incident angle of 5 degrees and preferably 98% or more at an incident angle of 40 degrees.

In addition, the spectral characteristics (i-1) and (i-2) are preferably satisfied on a dielectric multilayer film 1 side (substrate side).

In order to satisfy the spectral characteristic (i-1) and the spectral characteristic (i-2), for example, a dielectric multilayer film excellent in reflection characteristics of the light having a wavelength of 1,300 nm to 1,500 nm is used, and preferably, any of the dielectric multilayer films 1 to 3 satisfies all of characteristics (iiA-1) to (iiA-3) to be described later.

In the spectral characteristic (i-3), the average reflectance of the light having a wavelength of 750 nm to 900 nm is preferably 35% or more at an incident angle of 5 degrees and preferably 35% or more at an incident angle of 40 degrees.

In the spectral characteristic (i-4), the maximum reflectance of the light having a wavelength of 750 nm to 900 nm is preferably 83% or more at an incident angle of 5 degrees and preferably 76% or more at an incident angle of 40 degrees.

In addition, the spectral characteristics (i-3) and (i-4) are preferably satisfied on a dielectric multilayer film 3 side (light-absorbing layer side).

In order to satisfy the spectral characteristic (i-3) and the spectral characteristic (i-4), for example, a dielectric multilayer film excellent in reflection characteristics of the light having a wavelength of 750 nm to 900 nm is used, and preferably, any of the dielectric multilayer films 1 to 3 satisfies all of characteristics (iiC-1) to (iiC-3) to be described later.

In the spectral characteristic (i-5), the average transmittance of the light having a wavelength of 350 nm to 400 nm is preferably 0.1% or less at an incident angle of 0 degrees and preferably 0.5% or less at an incident angle of 40 degrees.

In the spectral characteristic (i-6), the maximum transmittance of the light having a wavelength of 350 nm to 400 nm is preferably 0.5% or less at an incident angle of 0 degrees and preferably 2.0% or less at an incident angle of 40 degrees.

In order to satisfy the spectral characteristic (i-5) and the spectral characteristic (i-6), for example, a dielectric multilayer film excellent in reflection characteristics of the light having a wavelength of 350 nm to 400 nm is used, and preferably, any of the dielectric multilayer films 1 to 3 satisfies all of characteristics (iiB-1) to (iiB-3) to be described later.

The filter preferably satisfies the following spectral characteristic (i-7).

When a light is incident from either of the main surfaces, an (absorption loss amount)_{X} at a wavelength of X nm is defined as follows: (absorption loss amount)_{X}[%]=100−(transmittance at incident angle of 0 degrees)−(reflectance at incident angle of 5 degrees). (i-7) An integral value of an (absorption loss amount)₄₃₀₋₁₁₀₀ at a wavelength of 430 nm to 1,100 nm is 10,000 or more.

The (absorption loss amount)_{X} is an index indicating a shielding degree corresponding to absorption characteristics at a wavelength of X nm, and the larger a numerical value thereof is, the more the light of the wavelength X is shielded by absorption. The integral value in the spectral characteristic (i-7) is more preferably 12,000 or more.

In order to satisfy the spectral characteristic (i-7), for example, a near-infrared ray absorbing dye having a maximum absorption wavelength in a wavelength range of 430 nm to 1,100 nm may be used.

The filter preferably satisfies all of the following spectral characteristics (i-8) to (i-11).
(i-8) An average reflectance of a light having a wavelength of 420 nm to 650 nm when the light is incident from the one main surface is 5% or less at an incident angle of 5 degrees and 5% or less at an incident angle of 40 degrees.
(i-9) A maximum reflectance of the light having a wavelength of 420 nm to 650 nm when the light is incident from the one main surface is 10% or less at an incident angle of 5 degrees and 15% or less at an incident angle of 40 degrees.
(i-10) An average reflectance of a light having a wavelength of 1,030 nm to 1,150 nm when the light is incident from the one main surface is 9% or less at an incident angle of 5 degrees and 10% or less at an incident angle of 40 degrees.
(i-11) A maximum reflectance of the light having a wavelength of 1,030 nm to 1,150 nm when the light is incident from the one main surface is 10% or less at an incident angle of 5 degrees and 15% or less at an incident angle of 40 degrees.

Satisfying all of the spectral characteristics (i-8) to (i-11) means that the reflection characteristics of light in a visible light region and a target wavelength region are low.

In the spectral characteristic (i-8), the average reflectance of the light having a wavelength of 420 nm to 650 nm is more preferably 4.5% or less at an incident angle of 5 degrees and more preferably 4.5% or less at an incident angle of 40 degrees.

In the spectral characteristic (i-9), the maximum reflectance of the light having a wavelength of 420 nm to 650 nm is more preferably 7.5% or less at an incident angle of 5 degrees and more preferably 13.9% or less at an incident angle of 40 degrees.

In the spectral characteristic (i-10), the average reflectance of the light having a wavelength of 1,030 nm to 1,150 nm is more preferably 6.0% or less at an incident angle of 5 degrees and more preferably 6.0% or less at an incident angle of 40 degrees.

In the spectral characteristic (i-11), the maximum reflectance of the light having a wavelength of 1,030 nm to 1,150 nm is more preferably 7.0% or less at an incident angle of 5 degrees and more preferably 11.0% or less at an incident angle of 40 degrees.

In addition, the spectral characteristics (i-8) to (i-11) are preferably satisfied on the dielectric multilayer film 1 side (substrate side).

In order to satisfy the spectral characteristics (i-8) to (i-11), it is preferable that any of the dielectric multilayer films 1 to 3 satisfy all of the characteristics (iiA-1) to (iiA-3) to be described later.

The filter preferably satisfies all of the following spectral characteristics (i-12) to (i-15).
(i-12) An average reflectance of a light having a wavelength of 420 nm to 650 nm when the light is incident from the other main surface is 5% or less at an incident angle of 5 degrees and 5% or less at an incident angle of 40 degrees.
(i-13) A maximum reflectance of the light having a wavelength of 420 nm to 650 nm when the light is incident from the other main surface is 10% or less at an incident angle of 5 degrees and 15% or less at an incident angle of 40 degrees.
(i-14) An average reflectance of a light having a wavelength of 1,030 nm to 1,150 nm when the light is incident from the other main surface is 9% or less at an incident angle of 5 degrees and 10% or less at an incident angle of 40 degrees.
(i-15) A maximum reflectance of the light having a wavelength of 1,030 nm to 1,150 nm when the light is incident from the other main surface is 10% or less at an incident angle of 5 degrees and 15% or less at an incident angle of 40 degrees.

Satisfying all of the spectral characteristics (i-12) to (i-15) means that the reflection characteristics of light in a visible light region and a target wavelength region are low.

In the spectral characteristic (i-12), the average reflectance of the light having a wavelength of 420 nm to 650 nm is more preferably 4.0% or less at an incident angle of 5 degrees and more preferably 4.0% or less at an incident angle of 40 degrees.

In the spectral characteristic (i-13), the maximum reflectance of the light having a wavelength of 420 nm to 650 nm is more preferably 8.0% or less at an incident angle of 5 degrees and more preferably 14.5% or less at an incident angle of 40 degrees.

In the spectral characteristic (i-14), the average reflectance of the light having a wavelength of 1,030 nm to 1,150 nm is more preferably 6.0% or less at an incident angle of 5 degrees and more preferably 6.0% or less at an incident angle of 40 degrees.

In the spectral characteristic (i-15), the maximum reflectance of the light having a wavelength of 1,030 nm to 1,150 nm is more preferably 8.0% or less at an incident angle of 5 degrees and more preferably 11.0% or less at an incident angle of 40 degrees.

In addition, the spectral characteristics (i-12) to (i-15) are preferably satisfied on the dielectric multilayer film 3 side (light-absorbing layer side).

In order to satisfy the spectral characteristics (i-12) to (i-15), it is preferable that any of the dielectric multilayer films 1 to 3 satisfy all of the characteristics (iiC-1) to (iiC-3) to be described later.

### Glass Substrate

The filter includes a glass substrate. Since the filter includes at least three dielectric multilayer films, a material having high rigidity such as glass is preferable instead of a resin film as a substrate. Thus, warpage during film formation can be reduced.

The glass substrate may be a transparent glass substrate or a light-absorbing glass substrate, and a light-absorbing glass substrate is preferable. Absorption characteristics of the light-absorbing glass substrate do not cause a light shielding region to shift depending on an incident angle of light unlike the reflection characteristics of the dielectric multilayer film, and thus high light shielding properties can be exhibited even at a high incident angle.

The light-absorbing glass is preferably a glass containing ytterbium. The glass containing ytterbium has a characteristic of absorbing light in a near-infrared light region having a wavelength of 900 nm to 1,000 nm. Further, since a waveform of an absorption band is steep, transmittance in a region other than a maximum absorption wavelength region is excellent. Therefore, transmittance in the visible light region and in a region from visible light to a near-infrared light region of about 800 nm is excellent.

Each component that can constitute the glass and a preferred content thereof (in terms of mol % based on an oxide) will be described below. In the present description, unless otherwise specified, the content of each component and a total content thereof are expressed in terms of mol % based on an oxide.

Yb₂O₃ is a component for efficiently absorbing light having a wavelength around 900 nm to 1,000 nm, particularly light having a wavelength of 940 nm, and reducing the transmittance. In the glass of the present embodiment, when a content of Yb₂O₃ is 20% or more, an effect thereof can be sufficiently obtained, and when the content is 60% or less, problems such as deterioration of devitrification resistance of the glass, deterioration of meltability, and generation of stray light due to fluorescence are unlikely to occur.

Therefore, the content of Yb₂O₃ is preferably 20% to 60%, more preferably 25% to 60%, further preferably 30% to 60%, still more preferably 35% to 60%, particularly preferably more than 40% and 60% or less, and most preferably 45% to 60%.

SiO₂ is a main component that forms glass, and is a component for improving devitrification resistance and viscosity to a liquid phase temperature of the glass. When a content of SiO₂ in the glass of the present embodiment is 0.1% or more, problems such as unstability of glass, reduction in weather resistance, and generation of striae in the glass are unlikely to occur. When the content of SiO₂ is 50% or less, problems such as deterioration of glass meltability are unlikely to occur.

Therefore, the content of SiO₂ is preferably 0.1% to 50%, more preferably 0.1% to 40%, further preferably 0.1% to 30%, still more preferably 0.1% to 20%, particularly preferably 0.1% to 10%, and most preferably 0.1% to 9%.

B₂O₃ is a main component that forms glass, and is a component for improving devitrification resistance and viscosity to a liquid phase temperature of the glass. When a content of B₂O₃ in the glass of the present embodiment is 15% or more, problems such as unstability of glass are unlikely to occur. When the content of B₂O₃ is 40% or less, problems such as reduction in weather resistance of the glass and generation of striae in the glass are unlikely to occur.

Therefore, the content of B₂O₃ is preferably 15% to 40%, more preferably 15% to 38%, further preferably 15% to 36%, still more preferably 15% to 34%, particularly preferably 15% to 32%, and most preferably 15% to 30%.

The light-absorbing glass preferably contains at least one of SiO₂ and B₂O₃ from the viewpoint of obtaining a stable glass. A total content of the above components is preferably more than 65% from the viewpoint of hardly causing problems such as unstability of glass, and is preferably 80% or less from the viewpoint of hardly causing problems such as deterioration of glass meltability.

Therefore, the total content is more preferably more than 65% and 79% or less, further preferably more than 65% and 78% or less, still more preferably more than 65% and 77% or less, particularly preferably more than 65% and 76% or less, and most preferably more than 65% and 75% or less.

P₂O₅ is a component for improving meltability and stability of the glass. In the glass of the present embodiment, a content of P₂O₅ is preferably 0% to 15%. When the content of P₂O₅ is 15% or less, problems such as deterioration of weather resistance of the glass, phase separation of the glass, and generation of striae in the glass are unlikely to occur.

The content of P₂O₅ is more preferably 1% to 13%, further preferably 2% to 12%, still more preferably 3% to 11%, and most preferably 4% to 10%.

GeO₂ is a component for improving devitrification resistance and viscosity to a liquid phase temperature of the glass. In the glass of the present embodiment, a content of GeO₂ is preferably 0% to 15%. When the content of GeO₂ is 15% or less, problems such as deterioration of glass meltability are unlikely to occur.

The content of GeO₂ is more preferably 0% to 13%, further preferably 0% to 11%, still more preferably 0% to 9%, and most preferably 0% to 7%.

Ga₂O₃ is a component for increasing the Young's modulus of the glass and improving the meltability and the stability. In the glass of the present embodiment, a content of Ga₂O₃ is preferably 0% to 30%. When the content of Ga₂O₃ is 30% or less, problems such as deterioration of devitrification resistance of the glass, increase of reflectance, and generation of stray light due to reflected light are unlikely to occur.

The content of Ga₂O₃ is more preferably 0.5% to 28%, further preferably 1% to 26%, still more preferably 2% to 24%, and most preferably 3% to 22%.

ZrO₂ is a component for increasing the Young's modulus of the glass and improving viscosity to a liquid phase temperature of the glass. In the glass of the present embodiment, a content of ZrO₂ is preferably 0% to 7%. When the content of ZrO₂ is 7% or less, problems such as deterioration of devitrification resistance of the glass and deterioration of meltability are unlikely to occur.

The content of ZrO₂ is more preferably 0% to 6%, further preferably 0% to 5%, still more preferably 0% to 4%, and most preferably 0% to 3%.

La₂O₃ is a component for increasing the Young's modulus of the glass and improving meltability. In the glass of the present embodiment, a content of La₂O₃ is preferably 0.1% to 20%. When the content of La₂O₃ is 0.1% or more, an effect thereof is sufficiently obtained, and when the content is 20% or less, problems such as deterioration of devitrification resistance of the glass, increase of reflectance, and generation of stray light due to reflected light are unlikely to occur.

The content of La₂O₃ is more preferably 0.5% to 19%, further preferably 1% to 18%, still more preferably 2% to 17%, and most preferably 2% to 16%.

Al₂O₃ is a component for increasing the Young's modulus of the glass and reducing a refractive index of the glass. In the glass of the present embodiment, a content of Al₂O₃ is preferably 0.1% to 20%. When the content of Al₂O₃ is 0.1% or more, an effect thereof is sufficiently obtained, and when the content is 20% or less, problems such as deterioration of devitrification resistance of the glass, increase of reflectance, and generation of stray light due to reflected light are unlikely to occur.

The content is more preferably 0.1% to 18%, further preferably 0.1% to 15%, still more preferably 0.1% to 13%, and most preferably 0.1% to 11%.

A ratio of a total content of components of Al₂O₃, GeO₂, Ga₂O₃, and P₂O₅ to a total content of components of SiO₂ and B₂O₃, that is, (total content of Al₂O₃, GeO₂, Ga₂O₃, and P₂O₅)/(total content of SiO₂ and B₂O₃) is preferably less than 0.1 from the viewpoint of vitrifying glass containing a Yb component without devitrifying the glass.

The light-absorbing glass may contain an alkali metal oxide, an alkaline earth metal oxide, Sb₂O₃, Cl, F, and other components as long as the object of the present invention is not impaired.

As the glass substrate in the filter, when being used for an optical filter, it is desirable that reflectance of glass is reduced in order to prevent occurrence of stray light due to reflected light on a glass surface. The reflectance of the glass is determined by a refractive index, and typically, a refractive index at a wavelength of 588 nm is preferably 1.700 to 1.900.

As the glass substrate, when being used in a so-called dual band pass filter having a function of selectively transmitting visible light and specific near-infrared light, the glass substrate is usually used with a thickness of 3 mm or less. From the viewpoint of reducing a weight of the component, the thickness is preferably 2 mm or less, more preferably 1 mm or less, further preferably 0.5 mm or less, and still more preferably 0.3 mm or less. In addition, from the viewpoint of ensuring the strength of the glass, the thickness is preferably 0.05 mm or more.

The glass substrate in the filter can be prepared, for example, as follows.

First, raw materials are weighed and mixed so as to fall within the above composition range (mixing step). The raw material mixture is accommodated in a platinum crucible, and heated and melted at a temperature of 1,200° C. to 1,650° C. in an electric furnace (melting step). After being sufficiently stirred and clarified, the raw material mixture is cast into a mold, cut and polished to form a flat plate having a predetermined thickness (molding step).

In the melting step of the above manufacturing method, the highest temperature of the glass during glass melting is preferably 1,650° C. or lower. When the highest temperature of the glass during glass melting is equal to or lower than the above temperature, problems such as crystallization of the glass and generation of unmelted foreign matter in the glass are unlikely to occur. The above temperature is more preferably 1,625° C. or lower, and further preferably 1,600° C. or lower.

When the temperature in the melting step is too low, problems such as devitrification occurring during melting and a long time required for burn-through may occur, and thus the temperature is preferably 1,300° C. or higher, and more preferably 1,350° C. or higher.

### Light-absorbing Layer

The filter includes a light-absorbing layer containing a near-infrared ray absorbing dye (NIR dye). Accordingly, it is possible to compensate for a region where light is not shielded due to the reflection characteristics of the dielectric multilayer film by the absorption characteristics that are not affected by the incident angle.

The light-absorbing layer preferably satisfies both the following spectral characteristics (iii-1) and (iii-2). (iii-1) When a shortest wavelength at which an internal transmittance is 30% in a spectral transmittance curve at a wavelength of 650 nm to 720 nm is defined as λ_{A_VIS(30%)}, and a shortest wavelength at which an internal transmittance is 30% in a spectral transmittance curve at a wavelength of 720 nm to 1,000 nm is defined as λ_{A_IR (30%)}, the following relational expression is satisfied:

$$\vert {λ}_{A \_ IR ( 30 \% )} - {λ}_{A \_ VIS ( 30 \% )} \vert \geq 100 nm .$$

(iii-2) When an optical density at a wavelength of 720 nm is defined as OD_₇₂₀, the following relational expression is satisfied:

$${OD}_{\_ 720} \geq 2. .$$

|λ_{A_IR(30%)}−λ_{A_VIS(30%)}| in the characteristic (iii-1) is an index of a near-infrared light absorption band centered at 720 nm, and being 100 nm or more means that the light-absorbing layer absorbs a wide range of light in the region.

|λ_{A_IR(30%)}−λ_{A_VIS(30%)}| is more preferably 120 nm or more. In addition, |λ_{A_IR(30%)}−λ_{A_VIS(30%)}| is preferably 150 nm or less from the viewpoint that it is more difficult to keep the transmittance in the visible light region high as the maximum absorption wavelength of the dye is in a long wavelength region.

In order to satisfy the characteristic (iii-1), for example, a combination of two kinds of dyes having different maximum absorption wavelengths and existing in a region of 680 nm to 800 nm, preferably a combination of a dye having a maximum absorption wavelength in 680 nm to 740 nm and a dye having a maximum absorption wavelength in 740 nm to 800 nm may be used as the near-infrared ray absorbing dye. In addition, a squarylium dye may be used from the viewpoint of achieving a wide range absorption with a small addition amount.

The characteristic (iii-2) means that the light-absorbing layer has high near-infrared light shielding properties at 720 nm.

OD₇₂₀ is preferably 2.1 or more, and more preferably 2.2 or more.

In order to satisfy the characteristic (iii-2), for example, a squarylium dye of a symmetrical type may be used as the near-infrared ray absorbing dye from the viewpoint of strongly absorbing light around 720 nm and maintaining high transmittance in the visible light region.

The near-infrared ray absorbing dye (NIR dye) is preferably a dye having a maximum absorption wavelength in a wavelength region of 680 nm to 800 nm in dichloromethane (hereinafter, also referred to as an “NIR dye”). By including such a dye, as shown in the above characteristics (iii-1) and (iii-2), the light-absorbing layer can absorb a wide range of light in the near-infrared light absorption band centered at 720 nm, and can easily achieve both the visible light transmittance at 450 nm and the near-infrared light shielding properties at 720 nm.

As the near-infrared ray absorbing dye, from the viewpoint of being able to absorb a wide range of light in the near-infrared region while maintaining the transmittance in the visible light region, preferably a combination of two or more kinds of, more preferably three kinds of dyes having different maximum absorption wavelengths and existing in a region of 680 nm to 800 nm may be used. In particular, the near-infrared ray absorbing dye preferably includes a dye having a maximum absorption wavelength at a wavelength of 700 nm or more and less than 730 nm, a dye having a maximum absorption wavelength at a wavelength of 730 nm or more and less than 760 nm, and a dye having a maximum absorption wavelength at a wavelength of 761 nm or more and less than 800 nm.

The NIR dye is preferably at least one selected from the group consisting of a squarylium dye, a cyanine dye, a phthalocyanine dye, a naphthalocyanine dye, a dithiol metal complex dye, an azo dye, a polymethine dye, a phthalide dye, a naphthoquinone dye, an anthraquinone dye, an indophenol dye, a pyrylium dye, a thiopyrylium dye, a croconium dye, a tetradehydrocholine dye, a triphenylmethane dye, an aminium dye, and a diimmonium dye.

The NIR dye particularly preferably includes at least one dye selected from a squarylium dye, a phthalocyanine dye, and a cyanine dye. Among these NIR dyes, it is further preferable that either of or both a squarylium dye and a cyanine dye be included from the viewpoint of spectroscopy, and it is preferable that a phthalocyanine dye be included from the viewpoint of durability.

A content of the NIR dye in the light-absorbing layer is preferably 10 mass % or more, more preferably 20 mass % or less, and still more preferably 15 mass % or less. In a case where two or more compounds are combined, the above content is a sum of respective compounds.

The light-absorbing layer preferably contains a near-infrared ray absorbing dye and a resin, and the resin is not limited as long as it is a transparent resin, and one or more kinds of transparent resins selected from a polyester resin, an acrylic resin, an epoxy resin, an ene-thiol resin, a polycarbonate resin, a polyether resin, a polyarylate resin, a polysulfone resin, a polyethersulfone resin, a poly(p-phenylene) resin, a polyarylene ether phosphine oxide resin, a polyamide resin, a polyimide resin, a polyamide-imide resin, a polyolefin resin, a cyclic olefin resin, a polyurethane resin, a polystyrene resin, and the like are used. These resins may be used alone, or may be used by mixing two or more kinds thereof.

From the viewpoint of spectral characteristics, glass transition point (Tg), and adhesion of the light-absorbing layer, one or more kinds of resins selected from a polyimide resin, a polycarbonate resin, a polyester resin, and an acrylic resin are preferable.

In a case where a plurality of compounds are used as the NIR dye or other dyes, those compounds may be included in the same light-absorbing layer or may be included in different light-absorbing layers.

The light-absorbing layer can be formed by dissolving or dispersing a dye, a resin or raw material components of the resin, and respective components blended as necessary in a solvent to prepare a coating solution, applying the coating solution to a support, drying the coating solution, and further curing the coating solution as necessary. The support may be a light-absorbing glass substrate or may be a peelable support used only when the light-absorbing layer is formed. In addition, the solvent may be a dispersion medium capable of stably dispersing components or a solvent capable of dissolving components.

The coating solution may contain a surfactant in order to improve voids due to fine bubbles, depressions due to adhesion of foreign substances and the like, and repelling in a drying process. Further, for the application of the coating solution, for example, a dip coating method, a cast coating method, or a spin coating method can be used. In a case where the coating solution contains a raw material component of the transparent resin, a curing process such as thermal curing or photocuring is further performed.

The light-absorbing layer can also be manufactured into a film shape by extrusion molding. The filter can be manufactured by laminating the obtained film-shaped absorption layer on the light-absorbing glass substrate and integrating those by thermal press fitting or the like.

The light-absorbing layer may be provided in the optical filter by one layer or two or more layers. In a case where the light-absorbing layer is provided by two or more layers, respective layers may have the same configuration or different configurations.

A thickness of the light-absorbing layer is preferably 5 μm or less from the viewpoint of in-plane film thickness distribution and appearance quality in a substrate after coating, and more preferably 2 μm or less from the viewpoint of reducing an amount of thermal expansion of the resin, and is preferably 0.5 μm or more from the viewpoint of exhibiting desired spectral characteristics at an appropriate dye concentration. In a case where the optical filter has two or more layers of light-absorbing layers, a total thickness of the respective light-absorbing layers is preferably within the above range.

### Dielectric Multilayer Film

The filter includes three dielectric multilayer films on one main surface side and the other main surface side of the glass substrate, and a surface of the light-absorbing layer. The larger a thickness of the dielectric multilayer film, the easier to control the spectral characteristics. On the other hand, when the thickness is too large, stress is likely to be generated, which may cause deformation. By providing the dielectric multilayer films at three positions, it is possible to disperse the role in controlling the spectral characteristics and avoid the thickness from being concentrated on one of the multilayer films.

The dielectric multilayer films 1 to 3 are preferably designed as reflective films that reflect a part of near-infrared light or reflective films that reflect near ultraviolet light.

At least one of the dielectric multilayer films 1 to 3 preferably satisfies all of the following characteristics (iiA-1) to (iiA-3).
(iiA-1) A total number of laminated layers is 1 to 80.
(iiA-2) High refractive index layers HA having a refractive index of 1.8 or more and 2.5 or less and low refractive index layers LA having a refractive index of 1.4 or more and 1.6 or less are provided, and a ratio of a total physical film thickness of the high refractive index layers HA to a total physical film thickness of the low refractive index layers LA is 0.3 to 0.8.
(iiA-3) When a layer having a QWOT of 1.0 or more and being n-th closest to the glass substrate among the high refractive index layers HA is defined as a HAₙ layer, and a layer having a QWOT of 1.0 or more and being next closest to the glass substrate with respect to the HAₙ layer among the low refractive index layers LA is defined as a LAₙ layer,
a layer between the HAₙ layer and the LAₙ layer is an MA₂ₙ₋₁ layer including a single layer or a plurality of layers and having a total QWOT of 1 or less,
a layer between the LAₙ layer and a HAₙ₊₁ layer having a QWOT of 1.0 or more and being (n+1)-th closest to the glass substrate is a MA₂ₙ layer including a single layer or a plurality of layers and having a total QWOT of 1 or less, and
a repeating structure represented by the following formula is provided where n is a natural number of 2 or more:

(HA₁ layer/MA₁ layer/LA₁ layer/MA₂ layer) . . . (HAₙ layer/MA₂ₙ₋₁ layer/LAₙ layer/MA₂ₙ layer).

By satisfying the characteristics (iiA-1) to (iiA-3), a dielectric multilayer film can be obtained which is excellent in transmittance of visible light and transmittance in a short wavelength region of near-infrared light, preferably near-infrared light of 1,000 nm or less, and is excellent in sharp cutting properties in a long wavelength region of near-infrared light, preferably near-infrared light of 1,100 nm or more.

The total number of laminated layers in (iiA-1) is more preferably 1 to 70.

The ratio of the total physical film thicknesses in (iiA-2) is more preferably 0.4 to 0.6.

The n in (iiA-3) is more preferably 2 to 8. In addition, the repeating structures may be continuous or may be separated from each other, but are preferably continuous from the viewpoint of obtaining desired spectral characteristics.

The refractive index means a refractive index at a wavelength of 500 nm. The same applies to the subsequent characteristics.

In addition, the QWOT means a quarter-wave optical thickness.

At least one of the dielectric multilayer films 1 to 3 preferably satisfies all of the following characteristics (iiB-1) to (iiB-3).
(iiB-1) A total number of laminated layers is 1 to 60.
(iiB-2) A high refractive index layer HB having a refractive index of 1.8 or more and 2.5 or less and a low refractive index layer LB having a refractive index of 1.4 or more and 1.6 or less are provided, and a ratio of a total physical film thickness of the high refractive index layer HB to a total physical film thickness of the low refractive index layer LB is 0.2 to 0.8.
(iiB-3) When a high refractive index layer having a QWOT of 1.0 or more is defined as an HB₁ layer among the high refractive index layer HB and the low refractive index layer having a QWOT of 1.0 or more is defined as an LB₁ layer among the low refractive index layer LB,
a layer between the HB₁ layer and the LB₁ layer is an MB₁ layer including a single layer or a plurality of layers and having a QWOT of 1.0 or less per one layer of all the layers, and
one or more laminated structures represented by the following formula is provided:
(HB₁ layer/MB₁ layer/LB₁ layer).

By satisfying the characteristics (iiB-1) to (iiB-3), a dielectric multilayer film can be obtained which is excellent in transmittance of visible light and transmittance of near-infrared light, and is excellent in sharp cutting properties of near ultraviolet light.

The total number of laminated layers in (iiB-1) is more preferably 1 to 20.

The ratio of the total physical film thicknesses in (iiB-2) is more preferably 0.25 to 0.75.

The number of laminated structures in (iiB-3) is more preferably 1. In addition, in a case where two or more laminated structures are provided, the laminated structures may be continuous or may be separated from each other, but are preferably continuous from the viewpoint of obtaining desired spectral characteristics.

At least one of the dielectric multilayer films 1 to 3 preferably satisfies all of the following characteristics (iiC-1) to (iiC-3).
(iiC-1) A total number of laminated layers is 1 to 60.
(iiC-2) A high refractive index layer HC having a refractive index of 1.8 or more and 2.5 or less and a low refractive index layer LC having a refractive index of 1.4 or more and 1.6 or less are provided, a ratio of a total physical film thickness of the high refractive index layer HC to a total physical film thickness of the low refractive index layer LC is 0.5 to 0.9, and a ratio of a total QWOT of the high refractive index layer HC to a total QWOT of the low refractive index layer LC is 1.1 to 1.5.
(iiC-3) A laminated structure represented by the following formula is provided:

(HC₂ layer/LC₂ layer/HC₂ layer)/MC₁ layer/(LC₁ layer/HC₁ layer/LC₁ layer)/MC₁ layer/(HC₂ layer/LC₂ layer/HC₂ layer).

The HC₁ layer and the HC₂ layers are each independently a high refractive index layer having a QWOT of 1.0 or more.

The LC₁ layers and the LC₂ layers are each independently a low refractive index layer having a QWOT of 1.0 or more.

The MC₁ layers each independently include a single layer or a plurality of layers having a total QWOT of 1 or less.

By satisfying the characteristics (iiC-1) to (iiC-3), a dielectric multilayer film can be obtained which is excellent in transmittance of visible light and transmittance in a long wavelength region of near-infrared light, preferably near-infrared light of 1,100 nm or more, and is excellent in sharp cutting properties in a short wavelength region of near-infrared light, preferably near-infrared light of 1,000 nm or less.

The total number of laminated layers in (iiC-1) is more preferably 1 to 45.

The ratio of the total physical film thicknesses in (iiC-2) is more preferably 0.6 to 0.8.

The ratio of the total QWOTs in (iiC-2) is more preferably 1.1 to 1.35.

The laminated structure in (iiC-3) is more preferably the following laminated structure.

(HC₃ layer/MC₃ layer/HC₃ layer)/(MC₂ layer/LC₃ layer/MC₂ layer)/(HC₂ layer/LC₂ layer/HC₂ layer)/MC₁ layer/(LC₁ layer/HC₁ layer/LC₁ layer)/MC₁ layer/(HC₂ layer/LC₂ layer/HC₂ layer)/(MC₂ layer/LC₃ layer/MC₂ layer)/(HC₃ layer/MC₃ layer/HC₃ layer).

HC₁ layer, HC₂ layer, LC₁ layer, LC₂ layer, and MC₁ layer: the same as those defined above.

HC₃ layer: high refractive index layers each independently having a QWOT of 0.8 or more.

LC₃ layer: low refractive index layers each independently having a QWOT of 1.0 or more.

MC₂ layer: layers including a single layer or a plurality of layers each independently having a total QWOT of 1 or less.

MC₃ layer: layers including of a single layer or a plurality of layers each independently having a total QWOT of 2 or less.

It is more preferable that any of the dielectric multilayer films 1 to 3 satisfy each of the characteristics (iiA-1) to (iiA-3), the characteristics (iiB-1) to (iiB-3), and the characteristics (iiC-1) to (iiC-3). Accordingly, due to the reflection characteristics of the three dielectric multilayer films, the optical filter can be provided with sharp cutting properties of near ultraviolet light, high transmittance of visible light, and sharp cutting properties on a short wavelength side and a long wavelength side of a target wavelength. Particularly preferably, the dielectric multilayer film 1 satisfies the characteristics (iiA-1) to (iiA-3), the dielectric multilayer film 2 satisfies the characteristics (iiB-1) to (iiB-3), and the dielectric multilayer film 3 satisfies the characteristics (iiC-1) to (iiC-3).

The dielectric multilayer film is a laminate of dielectric films having different refractive indices. More specifically, examples of the dielectric films include a dielectric film having a low refractive index (low refractive index film), a dielectric film having a medium refractive index (medium refractive index film), and a dielectric film having a high refractive index (high refractive index film), and the laminate is composed of a dielectric multilayer film in which two or more of those dielectric films are laminated. The reflection characteristics can be adjusted by combining several types of dielectric films having different spectral characteristics when transmitting and selecting a desired wavelength band.

A refractive index of a high refractive index material at a wavelength of 500 nm is preferably 1.8 or more and 2.5 or less, and more preferably 1.9 or more and 2.5 or less. Examples of the high refractive index material include Ta₂O₅, TiO₂, TiO, and Nb₂O₅. Other commercially available products thereof include OS50 (Ti₃O₅), OS10 (Ti₄O₇), OA500 (a mixture of Ta₂O₅ and ZrO₂), and OA600 (a mixture of Ta₂O₅ and TiO₂) manufactured by Canon Optron, Inc. Among those, TiO₂ is preferable from the viewpoint of reproducibility in film formability and refractive index, stability, and the like.

A refractive index of a medium refractive index material at a wavelength of 500 nm is preferably more than 1.5 and less than 1.8, and more preferably 1.55 or more and less than 1.8. Examples of the medium refractive index material include ZrO₂, Nb₂O₅, Al₂O₃, HfO₂, OM-4 and OM-6 (mixtures of Al₂O₃ and ZrO₂) sold by Canon Optron, Inc., OA-100, and H4 and M2 (alumina lanthania) sold by Merck KGaA. Among those, Al₂O₃-based compounds and mixtures of Al₂O₃ and ZrO₂ are preferable from the viewpoint of reproducibility in film formability and refractive index, stability, and the like. The medium refractive index film may be replaced with an equivalent film including a high refractive index film and a low refractive index film without using the medium refractive index material described above.

A refractive index of a low refractive index material at a wavelength of 500 nm is preferably 1.4 or more and 1.6 or less, and more preferably 1.45 or more and 1.5 or less.

Examples of the low refractive index material include SiO₂, SiOₓN_{y}, and MgF₂. Other commercially available products thereof include S₄F and S₅F (mixtures of SiO₂ and Al₂O₃) manufactured by Canon Optron, Inc. Among those, SiO₂ is preferable from the viewpoint of reproducibility in film formability, stability, economic efficiency, and the like.

A film thickness (physical film thickness) of the dielectric multilayer film 1 is

preferably 1 μm or more and more preferably 2 μm or more from the viewpoint of easily controlling the spectral characteristics, and is preferably 6 μm or less from the viewpoint of productivity and prevention of a reflection ripple in the visible light region.

A film thickness (physical film thickness) of the dielectric multilayer film 2 is preferably 0.2 μm or more and more preferably 0.5 μm or more from the viewpoint of easily controlling the spectral characteristics, and is preferably 6 μm or less from the viewpoint of productivity and prevention of a reflection ripple in the visible light region.

A film thickness (physical film thickness) of the dielectric multilayer film 3 is preferably 1 μm or more and more preferably 2 μm or more from the viewpoint of easily controlling the spectral characteristics, and is preferably 6 μm or less from the viewpoint of productivity and prevention of a reflection ripple in the visible light region.

For formation of the dielectric multilayer film, for example, a vacuum film formation process such as a CVD method, a sputtering method, or a vacuum deposition method, a wet film formation process such as a spraying method or a dipping method, or the like can be used.

The filter may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have high visible light transmittance and have light absorbing properties in a wide range of an infrared wavelength region exceeding 1,200 nm, and thus can be used in a case where shielding properties of infrared light are required.

### Imaging Device

The imaging device according to the present invention preferably includes the optical filter according to the present invention described above. The imaging device preferably further includes a solid state image sensor and an imaging lens. The optical filter according to the present embodiment can be used, for example, by being disposed between the imaging lens and the solid state image sensor, or by being directly attached to the solid state image sensor, the imaging lens, or the like of the imaging device via an adhesive layer. By providing the filter which is excellent in transmittance of visible light and specific near-infrared light, has shielding properties of specific near-infrared light, and has a spectral curve hardly shifted even at a high incident angle, it is possible to obtain an imaging device excellent in color reproducibility even for light at a high incident angle.

When the optical filter is to be mounted on the imaging device, it is generally preferable that the dielectric multilayer film 1 be on a lens side and the dielectric multilayer film 3 be on a sensor side, but the present invention is not limited thereto.

As described above, the present description discloses the following optical filters and the like.
[1] An optical filter including a dielectric multilayer film 1, a glass substrate, a dielectric multilayer film 2, a light-absorbing layer, and a dielectric multilayer film 3 in this order, in which
the light-absorbing layer contains a near-infrared ray absorbing dye, and
the optical filter satisfies all of the following spectral characteristics (i-1) to (i-6).
(i-1) An average reflectance of a light having a wavelength of 1,300 nm to 1,500 nm when the light is incident from one main surface of the optical filter is 90% or more at an incident angle of 5 degrees and 90% or more at an incident angle of 40 degrees.
(i-2) A maximum reflectance of the light having a wavelength of 1,300 nm to 1,500 nm when the light is incident from the one main surface is 95% or more at an incident angle of 5 degrees and 95% or more at an incident angle of 40 degrees.
(i-3) An average reflectance of a light having a wavelength of 750 nm to 900 nm when the light is incident from the other main surface of the optical filter is 30% or more at an incident angle of 5 degrees and 30% or more at an incident angle of 40 degrees.
(i-4) A maximum reflectance of the light having a wavelength of 750 nm to 900 nm when the light is incident from the other main surface is 80% or more at an incident angle of 5 degrees and 70% or more at an incident angle of 40 degrees.
(i-5) An average transmittance of a light having a wavelength of 350 nm to 400 nm is 1% or less at an incident angle of 0 degrees and 2% or less at an incident angle of 40 degrees.
(i-6) A maximum transmittance of the light having a wavelength of 350 nm to 400 nm is 2% or less at an incident angle of 0 degrees and 3% or less at an incident angle of 40 degrees.
[2] The optical filter according to [1], in which at least one of the dielectric multilayer films 1 to 3 satisfies all of the following characteristics (iiB-1) to (iiB-3).
(iiB-1) A total number of laminated layers is 1 to 60.
(iiB-2) A high refractive index layer HB having a refractive index of 1.8 or more and 2.5 or less and a low refractive index layer LB having a refractive index of 1.4 or more and 1.6 or less are provided, and a ratio of a total physical film thickness of the high refractive index layer HB to a total physical film thickness of the low refractive index layer LB is 0.2 to 0.8.
(iiB-3) When a high refractive index layer having a QWOT of 1.0 or more is defined as an HB₁ layer among the high refractive index layer HB and the low refractive index layer having a QWOT of 1.0 or more is defined as an LB₁ layer among the low refractive index layer LB,
a layer between the HB₁ layer and the LB₁ layer is an MB₁ layer including a single layer or a plurality of layers and having a QWOT of 1.0 or less per one layer of all the layers, and
one or more laminated structures represented by the following formula is provided: (HB₁ layer/MB₁ layer/LB₁ layer).
30 [3] The optical filter according to [1] or [2], in which at least one of the dielectric multilayer films 1 to 3 satisfies all of the following characteristics (iiA-1) to (iiA-3).
(iiA-1) A total number of laminated layers is 1 to 80.
(iiA-2) High refractive index layers HA having a refractive index of 1.8 or more and 2.5 or less and low refractive index layers LA having a refractive index of 1.4 or more and 1.6 or less are provided, and a ratio of a total physical film thickness of the high refractive index layers HA to a total physical film thickness of the low refractive index layers LA is 0.3 to 0.8.
(iiA-3) When a layer having a QWOT of 1.0 or more and being n-th closest to the glass substrate among the high refractive index layers HA is defined as a HAₙ layer, and a layer having a QWOT of 1.0 or more and being next closest to the glass substrate with respect to the HAₙ layer among the low refractive index layers LA is defined as a LAₙ layer,
a layer between the HAₙ layer and the LAₙ layer is an MA₂ₙ₋₁ layer including a single layer or a plurality of layers and having a total QWOT of 1 or less,
a layer between the LAₙ layer and a HAₙ₊₁ layer having a QWOT of 1.0 or more and being (n+1)-th closest to the glass substrate is a MA₂ₙ layer including a single layer or a plurality of layers and having a total QWOT of 1 or less, and
a repeating structure represented by the following formula is provided where n is a natural number of 2 or more:

(HA₁ layer/MA₁ layer/LA₁ layer/MA₂ layer) . . . (HAₙ layer/MA₂ₙ₋₁ layer/LAₙ layer/MA₂ₙ layer).
[4] The optical filter according to any of [1] to [3], in which at least one of the dielectric multilayer films 1 to 3 satisfies all of the following characteristics (iiC-1) to (iiC-3).
(iiC-1) A total number of laminated layers is 1 to 60.

(iiC-2) A high refractive index layer HC having a refractive index of 1.8 or more and 2.5 or less and a low refractive index layer LC having a refractive index of 1.4 or more and 1.6 or less are provided, a ratio of a total physical film thickness of the high refractive index layer HC to a total physical film thickness of the low refractive index layer LC is 0.5 to 0.9, and a ratio of a total QWOT of the high refractive index layer HC to a total QWOT of the low refractive index layer LC is 1.1 to 1.5.
(iiC-3) A laminated structure represented by the following formula is provided:

(HC₂ layer/LC₂ layer/HC₂ layer)/MC₁ layer/(LC₁ layer/HC₁ layer/LC₁ layer)/MC₁ layer/(HC₂ layer/LC₂ layer/HC₂ layer).

The HC₁ layer and the HC₂ layers are each independently a high refractive index layer having a QWOT of 1.0 or more.

The LC₁ layers and the LC₂ layers are each independently a low refractive index layer having a QWOT of 1.0 or more.

The MC₁ layers each independently include a single layer or a plurality of layers having a total QWOT of 1 or less.
[5] The optical filter according to any of [1] to [4], in which the glass substrate contains ytterbium.
[6] The optical filter according to any of [1] to [5], in which the optical filter satisfies the following spectral characteristic (i-7).

When a light is incident from either of the main surfaces, an (absorption loss amount)_{X} at a wavelength of X nm is defined as follows:

$$( absorption loss amount ) x [ \% ] = 100 - ( transmittance at incident angle of 0 degrees ) - ( reflectance at incident angle of 5 degrees ) .$$

(i-7) An integral value of an (absorption loss amount)₄₃₀₋₁₁₀₀ at a wavelength of 430 nm to 1,100 nm is 10,000 or more.
[7] The optical filter according to any of [1] to [6], in which the glass substrate includes, in terms of mol % based on an oxide:
0.1 mol % to 50 mol % of SiO₂;
15 mol % to 40 mol % of B₂O₃;
0 mol % to 15 mol % of P₂O₅; and
20 mol % to 60 mol % of Yb₂O₃.
[8] The optical filter according to any of [1] to [7], in which the near-infrared ray absorbing dye contains a dye having a maximum absorption wavelength in a wavelength region of 680 nm to 800 nm, and the light-absorbing layer satisfies both the following spectral characteristics (iii-1) and (iii-2).
(iii-1) When a shortest wavelength at which an internal transmittance is 30% in a spectral transmittance curve at a wavelength of 650 nm to 720 nm is defined as λ_{A_VIS(30%)}, and a shortest wavelength at which an internal transmittance is 30% in a spectral transmittance curve at a wavelength of 720 nm to 1,000 nm is defined as λ_{A_IR(30%)}, the following relational expression is satisfied:

$$\vert {λ}_{A IR ( 30 \% )} - {λ}_{A VIS ( 30 \% )} \vert \geq 100 nm .$$

(iii-2) When an optical density at a wavelength of 720 nm is defined as OD__{720,} the following relational expression is satisfied:

$${OD}_{\_ 720} \geq 2. .$$

[9 ] The optical filter according to any of [1] to [8], in which the optical filter satisfies all of the following spectral characteristics (i-8) to (i-11).
(i-8) An average reflectance of a light having a wavelength of 420 nm to 650 nm when the light is incident from the one main surface is 5% or less at an incident angle of 5 degrees and 5% or less at an incident angle of 40 degrees.
(i-9) A maximum reflectance of the light having a wavelength of 420 nm to 650 nm when the light is incident from the one main surface is 10% or less at an incident angle of 5 degrees and 15% or less at an incident angle of 40 degrees.
(i-10) An average reflectance of a light having a wavelength of 1,030 nm to 1,150 nm when the light is incident from the one main surface is 9% or less at an incident angle of 5 degrees and 10% or less at an incident angle of 40 degrees.
(i-11) A maximum reflectance of the light having a wavelength of 1,030 nm to 1,150 nm when the light is incident from the one main surface is 10% or less at an incident angle of 5 degrees and 15% or less at an incident angle of 40 degrees.

The optical filter according to any of [1] to [9], in which all of the following spectral characteristics (i-12) to (i-15) are satisfied.
(i-12) An average reflectance of a light having a wavelength of 420 nm to 650 nm when the light is incident from the other main surface is 5% or less at an incident angle of 5 degrees and 5% or less at an incident angle of 40 degrees.
(i-13) A maximum reflectance of the light having a wavelength of 420 nm to 650 nm when the light is incident from the other main surface is 10% or less at an incident angle of 5 degrees and 15% or less at an incident angle of 40 degrees.
(i-14) An average reflectance of a light having a wavelength of 1,030 nm to 1,150 nm when the light is incident from the other main surface is 9% or less at an incident angle of 5 degrees and 10% or less at an incident angle of 40 degrees.
(i-15) A maximum reflectance of the light having a wavelength of 1,030 nm to 1,150 nm when the light is incident from the other main surface is 10% or less at an incident angle of 5 degrees and 15% or less at an incident angle of 40 degrees.

[11] An imaging device including the optical filter according to any of [1] to [10].

### EXAMPLES

Next, the present invention will be described more specifically with reference to examples.

For measurement of each spectral characteristic, an ultraviolet-visible spectrophotometer (UH-4150 type, manufactured by Hitachi High-Tech Corporation) was used. The spectral characteristic in a case where an incident angle is not particularly specified is a value measured at an incident angle of 0 degrees (in a direction perpendicular to a main surface of an optical filter).

Dyes used in respective examples are as follows.

Compound 1 (cyanine compound): synthesized based on Dyes and pigments 73 (2007) 344-352.

Compound 2 (merocyanine compound): synthesized based on the description of German Patent No. 10109243. Compound 3 (squarylium compound): synthesized based on U.S. Pat No. 5543086.

The compounds 1 and 3 are near-infrared ray absorbing dyes (NIR dyes), and the compound 2 is a near ultraviolet absorbing dye (UV dye).

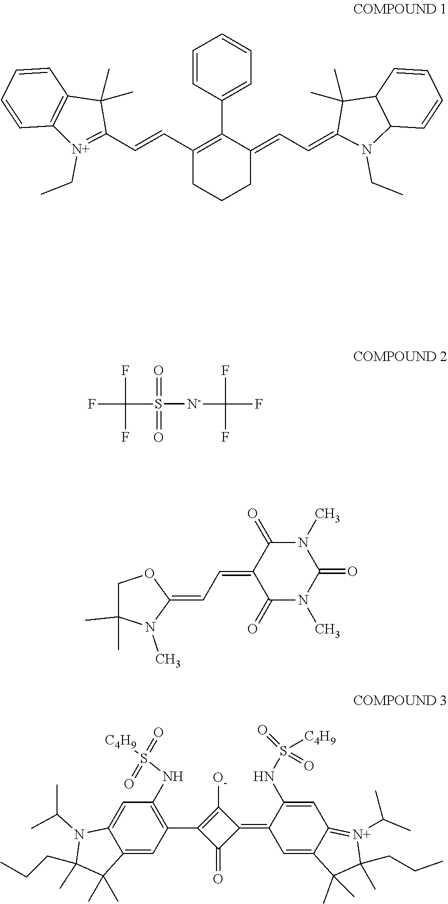

### Spectral Characteristics of Dye

Maximum absorption wavelengths in absorption spectrums measured after dissolving the above dyes (compounds 1 to 3) in dichloromethane are shown in Table 1 below.

### Glass Substrate

As the glass substrate, a glass A which is a light-absorbing glass, and a non-absorbing glass B were prepared.

As the glass A, raw materials including, in terms of mol % based on an oxide, 7.5% of SiO₂, 23.6% of B₂O₃, 7.5% of P₂O₅, 47.2% of Yb₂O₃, 11.8% of Ga₂O₃, and 2.4% of La₂O₃ were weighed and mixed, placed in a crucible having an internal volume of about 400 cc, and melted at 1,400° C. to 1,650° C. for 2 hours in an air atmosphere. Thereafter, the mixture was clarified, stirred, cast into a rectangular mold having a length of 100 mm, a width of 50 mm, and a height of 20 mm that was preheated to about 300° C. to 500° C., slowly cooled to room temperature at about −1° C./min, cut to have a predetermined thickness within a range of a length of 40 mm, a width of 30 mm, and a thickness of 0.3 mm to 1.5 mm, and optically polished on both sides to obtain a plate-shaped glass.

In addition, the glass B is a non-absorbing glass, and a D263 glass (borosilicate glass, commercially available product, manufactured by Schott) was used.

The following raw materials were used for each glass.
SiO₂: oxide
B₂O₃: one or more selected from an oxide, PBO₄, and H₃BO₃
P₂O₅: any one or more of H₃PO₄ and PBO₄
GeO₂: oxide
ZrO₂: oxide
Ga₂O₃: oxide
Yb₂O₃: oxide
La₂O₃: oxide
Al₂O₃: any one or more of an oxide and Al(OH)₃

The raw materials of the glass are not limited to the above, and known raw materials can be used.

Transmittance curves for a light having a wavelength of 350 nm to 1,200 nm of the glass A and the glass B (sheet thickness of both glass A and glass B: 0.4 mm, internal transmittance) are illustrated in FIG. 2.

### Light-Absorbing Layer

Any of the dyes of the compounds 1 to 3 was dissolved in a polyimide resin (C-3G30G, manufactured by Mitsubishi Gas Chemical Company, Inc.), mixed at a concentration shown in the following table, and stirred and dissolved at 50° C. for 2 hours to obtain a coating solution.

The obtained coating solution was applied onto an alkali glass (D263 glass, thickness: 0.2 mm, manufactured by SCHOTT) by a spin coating method to form a light-absorbing layer having a film thickness and spectral characteristics shown in the following Table 1.

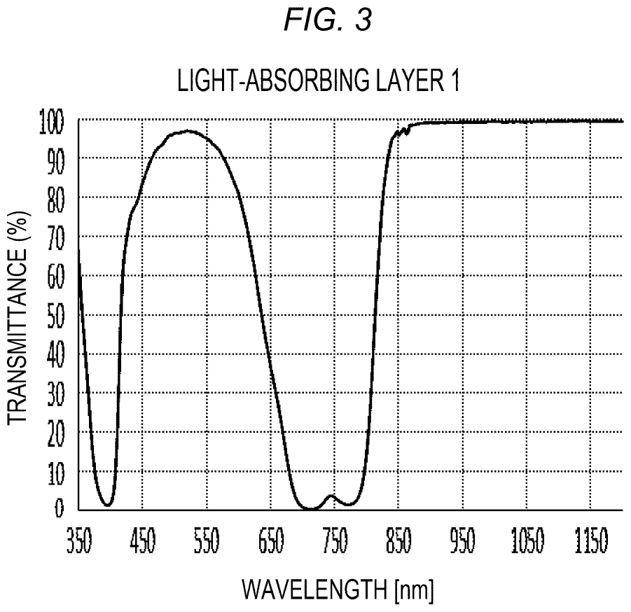

In addition, a transmittance curve for a light having a wavelength of 350 nm to 1,200 nm of the light-absorbing layer is illustrated in FIG. 3.

TABLE 1

| | | Light-absorbing layer 1 |
|---|---|---|
| Resin | | Polyimide |
| Content of dye (mass %) | Compound 1 (λMAX: 772 nm) | 5.6 |
| | Compound 2 (λMAX: 397 nm) | 4.9 |
| | Compound 3 (λMAX: 712 nm) | 4.1 |
| | Total | 14.6 |

| | |
|---|---|
| Film thickness (μm) | 1.4 |
| \|λ_{A}_{_{—}}_{IR(30%)} − λ_{A}_{_{—}}_{VIS(30%)}\| (nm) | 149 |
| OD_{_{—}}₇₂₀ | 2.21 |

### Example 1: Optical Filter

A dielectric multilayer film Al was formed by alternately laminating SiO₂ and TiO₂ on one main surface of the glass substrate (glass A) by vapor deposition.

A dielectric multilayer film B1 was formed by alternately laminating SiO₂ and TiO₂ on the other main surface of the glass substrate by vapor deposition.

A resin solution was applied to a surface of the dielectric multilayer film B1 with the same composition as that of the light-absorbing layer 1, and an organic solvent was removed by sufficiently heating, thereby forming a light-absorbing layer.

A dielectric multilayer film C1 was formed by alternately laminating SiO₂ and TiO₂ on a surface of the light-absorbing layer by vapor deposition.

Thus, an optical filter of Example 1 was manufactured.

### Example 2

A dielectric multilayer film A2 was formed by alternately laminating SiO₂ and TiO₂ on one main surface of the glass substrate (glass A) by vapor deposition.

A dielectric multilayer film C2 was formed by alternately laminating SiO₂ and TiO₂ on the other main surface of the glass substrate by vapor deposition.

A resin solution was applied to a surface of the dielectric multilayer film C2 with the same composition as that of the light-absorbing layer 1, and an organic solvent was removed by sufficiently heating, thereby forming a light-absorbing layer.

A dielectric multilayer film B2 was formed by alternately laminating SiO₂ and TiO₂ on a surface of the light-absorbing layer by vapor deposition.

Thus, an optical filter of Example 2 was manufactured.

### Example 3

A dielectric multilayer film C3 was formed by alternately laminating SiO₂ and TiO₂ on one main surface of the glass substrate (glass A) by vapor deposition.

A dielectric multilayer film A3 was formed by alternately laminating SiO₂ and TiO₂ on the other main surface of the glass substrate by vapor deposition.

A resin solution was applied to a surface of the dielectric multilayer film A3 with the same composition as that of the light-absorbing layer 1, and an organic solvent was removed by sufficiently heating, thereby forming a light-absorbing layer.

A dielectric multilayer film B3 was formed by alternately laminating SiO₂ and TiO₂ on a surface of the light-absorbing layer by vapor deposition.

Thus, an optical filter of Example 3 was manufactured.

### Example 4

An optical filter of Example 4 was manufactured in the same manner as in Example 1 except that the glass B was used instead of the glass A as the glass substrate.

### Example 5: Optical Filter

A dielectric multilayer film X1 was formed by alternately laminating SiO₂ and TiO₂ on one main surface of the glass substrate (glass A) by vapor deposition.

A dielectric multilayer film X2 was formed by alternately laminating SiO₂ and TiO₂ on the other main surface of the glass substrate by vapor deposition.

A resin solution was applied to a surface of the dielectric multilayer film X2 with the same composition as that of the light-absorbing layer 1, and an organic solvent was removed by sufficiently heating, thereby forming a light-absorbing layer.

A dielectric multilayer film X3 was formed by alternately laminating SiO₂ and TiO₂ on a surface of the light-absorbing layer by vapor deposition.

Thus, an optical filter of Example 5 was manufactured.

### Example 6: Optical Filter

A dielectric multilayer film Y1 was formed by alternately laminating SiO₂ and TiO₂ on one main surface of the glass substrate (glass A) by vapor deposition.

A resin solution was applied to the other main surface of the glass substrate with the same composition as that of the light-absorbing layer 1, and an organic solvent was removed by sufficiently heating, thereby forming a light-absorbing layer.

A dielectric multilayer film Y3 was formed by alternately laminating SiO₂ and TiO₂ on a surface of the light-absorbing layer by vapor deposition.

Thus, an optical filter of Example 6 was manufactured.

Configurations of the dielectric multilayer films A1 to A3, the dielectric multilayer films B1 to B3, and the dielectric multilayer films C1 to C3 are shown in the following Tables 2 to 10, respectively. An order of the numbers (No.) corresponds to a lamination order.

TABLE 2
Multilayer film: A1

| | | | | |
|---|---|---|---|---|
| | Film | Physical film | | |
| No. | material | thickness [nm] | QWOT | Total QWOT |

Substrate side

| | | | | | |
|---|---|---|---|---|---|
| 1 | TiO₂ | 19.42 | 0.341 | | |
| 2 | SiO₂ | 20.70 | 0.223 | | |
| 3 | TiO₂ | 134.69 | 2.368 | HA1 | |
| 4 | SiO₂ | 34.67 | 0.373 | MA1 | 0.665 |
| 5 | TiO₂ | 16.59 | 0.292 | | |
| 6 | SiO₂ | 263.74 | 2.838 | LA1 | |
| 7 | TiO₂ | 16.08 | 0.283 | MA2 | 0.658 |
| 8 | SiO₂ | 34.91 | 0.376 | | |
| 9 | TiO₂ | 88.57 | 1.557 | HA2 | |
| 10 | SiO₂ | 17.52 | 0.189 | MA3 | 0.568 |
| 11 | TiO₂ | 21.56 | 0.379 | | |
| 12 | SiO₂ | 238.65 | 2.568 | LA2 | |
| 13 | TiO₂ | 17.37 | 0.305 | MA4 | 0.728 |
| 14 | SiO₂ | 39.27 | 0.423 | | |
| 15 | TiO₂ | 108.37 | 1.905 | HA3 | |
| 16 | SiO₂ | 16.71 | 0.180 | MA5 | 0.451 |
| 17 | TiO₂ | 15.44 | 0.271 | | |
| 18 | SiO₂ | 222.63 | 2.396 | LA3 | |
| 19 | TiO₂ | 18.94 | 0.333 | MA6 | 0.748 |
| 20 | SiO₂ | 38.53 | 0.415 | | |
| 21 | TiO₂ | 111.97 | 1.969 | HA4 | |
| 22 | SiO₂ | 13.20 | 0.142 | MA7 | 0.380 |
| 23 | TiO₂ | 13.51 | 0.238 | | |
| 24 | SiO₂ | 210.54 | 2.266 | LA4 | |
| 25 | TiO₂ | 22.18 | 0.390 | MA8 | 0.748 |
| 26 | SiO₂ | 33.28 | 0.358 | | |
| 27 | TiO₂ | 110.05 | 1.935 | HA5 | |
| 28 | SiO₂ | 11.75 | 0.126 | MA9 | 0.450 |
| 29 | TiO₂ | 18.43 | 0.324 | | |
| 30 | SiO₂ | 211.05 | 2.271 | LA5 | |
| 31 | TiO₂ | 23.84 | 0.419 | MA10 | 0.761 |
| 32 | SiO₂ | 31.79 | 0.342 | | |
| 33 | TiO₂ | 128.40 | 2.258 | HA6 | |
| 34 | SiO₂ | 24.90 | 0.268 | MA11 | 0.426 |
| 35 | TiO₂ | 9.00 | 0.158 | | |
| 36 | SiO₂ | 173.65 | 1.869 | LA6 | |
| 37 | TiO₂ | 22.06 | 0.388 | MA12 | 0.617 |
| 38 | SiO₂ | 21.25 | 0.229 | | |
| 39 | TiO₂ | 128.14 | 2.253 | HA7 | |
| 40 | SiO₂ | 21.15 | 0.228 | MA13 | 0.618 |
| 41 | TiO₂ | 22.18 | 0.390 | | |
| 42 | SiO₂ | 216.06 | 2.325 | LA7 | |
| 43 | TiO₂ | 27.91 | 0.491 | MA14 | 0.777 |
| 44 | SiO₂ | 26.6 | 0.286 | | |
| 45 | TiO₂ | 62.35 | 1.096 | HA8 | |
| 46 | SiO₂ | 31.38 | 0.338 | MA15 | 0.769 |
| 47 | TiO₂ | 24.51 | 0.431 | | |
| 48 | SiO₂ | 242.12 | 2.605 | LA8 | |
| 49 | TiO₂ | 21.12 | 0.371 | MA16 | 0.709 |
| 50 | SiO₂ | 31.35 | 0.337 | | |
| 51 | TiO₂ | 100.44 | 1.766 | | |
| 52 | SiO₂ | 15.03 | 0.162 | | |
| 53 | TiO₂ | 22.54 | 0.396 | | |
| 54 | SiO₂ | 228.19 | 2.455 | | |
| 55 | TiO₂ | 19.49 | 0.343 | | |
| 56 | SiO₂ | 58.65 | 0.631 | | |
| 57 | TiO₂ | 30.47 | 0.536 | | |
| 58 | SiO₂ | 49.03 | 0.528 | | |
| 59 | TiO₂ | 26.72 | 0.470 | | |
| 60 | SiO₂ | 115.44 | 1.242 | | |

Light-absorbing layer side

| Total physical film thickness of high | 1,402.34 |
|---|---|
| refractive index film HA (TiO₂ film) [nm] | |
| Total physical film thickness of low | 2,693.74 |
| refractive index film LA (SiO₂ film) [nm] | |

| | |
|---|---|
| Ratio of physical film thickness HA/LA | 0.521 |

TABLE 3
Multilayer film: A2

| | | | | |
|---|---|---|---|---|
| | Film | Physical film | | Total |
| No. | material | thickness [nm] | QWOT | QWOT |

Substrate side

| | | | | | |
|---|---|---|---|---|---|
| 1 | TiO₂ | 19.97 | 0.351 | | |
| 2 | SiO₂ | 20.99 | 0.226 | | |
| 3 | TiO₂ | 134.94 | 2.373 | HA1 | |
| 4 | SiO₂ | 35.95 | 0.387 | MA1 | 0.670 |
| 5 | TiO₂ | 16.12 | 0.283 | | |
| 6 | SiO₂ | 264.86 | 2.850 | LA1 | |
| 7 | TiO₂ | 16.56 | 0.291 | MA2 | 0.643 |
| 8 | SiO₂ | 32.73 | 0.352 | | |
| 9 | TiO₂ | 86.13 | 1.514 | HA2 | |
| 10 | SiO₂ | 20.23 | 0.218 | MA3 | 0.590 |
| 11 | TiO₂ | 21.20 | 0.373 | | |
| 12 | SiO₂ | 245.32 | 2.640 | LA2 | |
| 13 | TiO₂ | 16.39 | 0.288 | MA4 | 0.702 |
| 14 | SiO₂ | 38.48 | 0.414 | | |
| 15 | TiO₂ | 104.75 | 1.842 | HA3 | |
| 16 | SiO₂ | 19.39 | 0.209 | MA5 | 0.498 |
| 17 | TiO₂ | 16.43 | 0.289 | | |
| 18 | SiO₂ | 235.85 | 2.538 | LA3 | |
| 19 | TiO₂ | 17.81 | 0.313 | MA6 | 0.727 |
| 20 | SiO₂ | 38.43 | 0.414 | | |
| 21 | TiO₂ | 77.74 | 1.367 | HA4 | |
| 22 | SiO₂ | 14.88 | 0.160 | MA7 | 0.662 |
| 23 | TiO₂ | 28.54 | 0.502 | | |
| 24 | SiO₂ | 236.57 | 2.546 | LA4 | |
| 25 | TiO₂ | 19.39 | 0.341 | MA8 | 0.773 |
| 26 | SiO₂ | 40.11 | 0.432 | | |
| 27 | TiO₂ | 84.99 | 1.494 | HA5 | |
| 28 | SiO₂ | 9.20 | 0.099 | MA9 | 0.637 |
| 29 | TiO₂ | 30.60 | 0.538 | | |
| 30 | SiO₂ | 218.83 | 2.355 | LA5 | |
| 31 | TiO₂ | 24.16 | 0.425 | MA10 | 0.768 |
| 32 | SiO₂ | 31.93 | 0.344 | | |
| 33 | TiO₂ | 122.41 | 2.152 | HA6 | |
| 34 | SiO₂ | 17.25 | 0.186 | MA11 | 0.409 |
| 35 | TiO₂ | 12.72 | 0.224 | | |
| 36 | SiO₂ | 199.24 | 2.144 | LA6 | |
| 37 | TiO₂ | 22.74 | 0.400 | MA12 | 0.692 |
| 38 | SiO₂ | 27.14 | 0.292 | | |
| 39 | TiO₂ | 120.79 | 2.124 | HA7 | |
| 40 | SiO₂ | 20.17 | 0.217 | MA13 | 0.545 |
| 41 | TiO₂ | 18.63 | 0.328 | | |
| 42 | SiO₂ | 217.97 | 2.345 | LA7 | |
| 43 | TiO₂ | 24.82 | 0.436 | MA14 | 0.809 |
| 44 | SiO₂ | 34.6 | 0.372 | | |
| 45 | TiO₂ | 53.32 | 0.937 | | |
| 46 | SiO₂ | 34.32 | 0.369 | | |
| 47 | TiO₂ | 24.47 | 0.430 | | |
| 48 | SiO₂ | 254.21 | 2.735 | | |
| 49 | TiO₂ | 17.92 | 0.315 | | |
| 50 | SiO₂ | 39.47 | 0.425 | | |
| 51 | TiO₂ | 96.35 | 1.694 | | |
| 52 | SiO₂ | 9.58 | 0.103 | | |
| 53 | TiO₂ | 23.28 | 0.409 | | |
| 54 | SiO₂ | 224.63 | 2.417 | | |
| 55 | TiO₂ | 17.83 | 0.313 | | |
| 56 | SiO₂ | 70.55 | 0.759 | | |
| 57 | TiO₂ | 23.27 | 0.409 | | |
| 58 | SiO₂ | 59.44 | 0.640 | | |
| 59 | TiO₂ | 24.35 | 0.428 | | |
| 60 | SiO₂ | 116.83 | 1.257 | | |

Air side

| Total physical film thickness of high | 1,318.62 |
|---|---|
| refractive index film HA (TiO₂ film) [nm] | |
| Total physical film thickness of low | 2,829.15 |
| refractive index film LA (SiO₂ film) [nm] | |

| | |
|---|---|
| Ratio of physical film thickness HA/LA | 0.466 |

TABLE 4
Multilayer film: A3

| | | | | |
|---|---|---|---|---|
| | Film | Physical film | | Total |
| No. | material | thickness [nm] | QWOT | QWOT |

Light-absorbing layer side

| | | | | | |
|---|---|---|---|---|---|
| 61 | TiO₂ | 19.81 | 0.348 | | |
| 60 | SiO₂ | 34.42 | 0.370 | | |
| 59 | TiO₂ | 42.87 | 0.754 | | |
| 58 | SiO₂ | 42.53 | 0.458 | | |
| 57 | TiO₂ | 22.07 | 0.388 | | |
| 56 | SiO₂ | 89.07 | 0.958 | | |
| 55 | TiO₂ | 9.00 | 0.158 | | |
| 54 | SiO₂ | 239.89 | 2.581 | | |
| 53 | TiO₂ | 17.26 | 0.303 | | |
| 52 | SiO₂ | 17.77 | 0.191 | | |
| 51 | TiO₂ | 103.04 | 1.812 | | |
| 50 | SiO₂ | 38.12 | 0.410 | | |
| 49 | TiO₂ | 15.13 | 0.266 | | |
| 48 | SiO₂ | 273.26 | 2.940 | | |
| 47 | TiO₂ | 18.14 | 0.319 | | |
| 46 | SiO₂ | 41.99 | 0.452 | | |
| 45 | TiO₂ | 51.07 | 0.898 | | |
| 44 | SiO₂ | 29.49 | 0.317 | | |
| 43 | TiO₂ | 28.09 | 0.494 | | |
| 42 | SiO₂ | 217.61 | 2.342 | | |
| 41 | TiO₂ | 23.07 | 0.406 | | |
| 40 | SiO₂ | 21.55 | 0.232 | | |
| 39 | TiO₂ | 132.12 | 2.323 | | |
| 38 | SiO₂ | 22.08 | 0.238 | M12 | 0.634 |
| 37 | TiO₂ | 22.57 | 0.397 | | |
| 36 | SiO₂ | 194.72 | 2.095 | L6 | |
| 35 | TiO₂ | 15.34 | 0.270 | M11 | 0.430 |
| 34 | SiO₂ | 14.93 | 0.161 | | |
| 33 | TiO₂ | 116.78 | 2.053 | H6 | |
| 32 | SiO₂ | 29.96 | 0.322 | M10 | 0.756 |
| 31 | TiO₂ | 24.68 | 0.434 | | |
| 30 | SiO₂ | 226.03 | 2.432 | L5 | |
| 29 | TiO₂ | 30.32 | 0.533 | M9 | 0.752 |
| 28 | SiO₂ | 20.34 | 0.219 | | |
| 27 | TiO₂ | 71.37 | 1.255 | II5 | |
| 26 | SiO₂ | 33.22 | 0.357 | M8 | 0.779 |
| 25 | TiO₂ | 23.95 | 0.421 | | |
| 24 | SiO₂ | 232.54 | 2.502 | L4 | |
| 23 | TiO₂ | 29.71 | 0.522 | M7 | 0.718 |
| 22 | SiO₂ | 18.18 | 0.196 | | |
| 21 | TiO₂ | 74.03 | 1.302 | H4 | |
| 20 | SiO₂ | 35.58 | 0.383 | M6 | 0.735 |
| 19 | TiO₂ | 20 | 0.352 | | |
| 18 | SiO₂ | 237.56 | 2.556 | L3 | |
| 17 | TiO₂ | 19.28 | 0.339 | M5 | 0.558 |
| 16 | SiO₂ | 20.34 | 0.219 | | |
| 15 | TiO₂ | 102.75 | 1.807 | H3 | |
| 14 | SiO₂ | 32.97 | 0.355 | M4 | 0.689 |
| 13 | TiO₂ | 19 | 0.334 | | |
| 12 | SiO₂ | 237.73 | 2.558 | L2 | |
| 11 | TiO₂ | 23.87 | 0.420 | M3 | 0.644 |
| 10 | SiO₂ | 20.81 | 0.224 | | |
| 9 | TiO₂ | 80.37 | 1.413 | H2 | |
| 8 | SiO₂ | 32.02 | 0.345 | M2 | 0.669 |
| 7 | TiO₂ | 18.46 | 0.325 | | |
| 6 | SiO₂ | 260.09 | 2.799 | L1 | |
| 5 | TiO₂ | 16.91 | 0.297 | M1 | 0.690 |
| 4 | SiO₂ | 36.51 | 0.393 | | |
| 3 | TiO₂ | 136.41 | 2.398 | H1 | |
| 2 | SiO₂ | 21.77 | 0.234 | | |
| 1 | TiO₂ | 20.14 | 0.354 | | |

Substrate side

| Total physical film thickness of high | 1,347.61 |
|---|---|
| refractive index film HA (TiO₂ film) [nm] | |
| Total physical film thickness of low | 2,773.08 |
| refractive index film LA (SiO₂ film) [nm] | |

| | |
|---|---|
| Ratio of physical film thickness HA/LA | 0.486 |

TABLE 5
Multilayer film: B1

| | | | |
|---|---|---|---|
| No. | Film material | Physical film thickness [nm] | QWOT |

Light-absorbing layer side

| | | | | |
|---|---|---|---|---|
| 17 | TiO₂ | 9.00 | 0.158 | |
| 16 | SiO₂ | 66.73 | 0.718 | |
| 15 | TiO₂ | 10.23 | 0.180 | |
| 14 | SiO₂ | 260.39 | 2.802 | LB1 |
| 13 | TiO₂ | 12.53 | 0.220 | MB1 |
| 12 | SiO₂ | 48.08 | 0.517 | |
| 11 | TiO₂ | 9.00 | 0.158 | |
| 10 | SiO₂ | 9.00 | 0.097 | |
| 9 | TiO₂ | 22.24 | 0.391 | |
| 8 | SiO₂ | 10.95 | 0.118 | |
| 7 | TiO₂ | 9.00 | 0.158 | |
| 6 | SiO₂ | 9.43 | 0.101 | |
| 5 | TiO₂ | 148.76 | 2.616 | HB1 |
| 4 | SiO₂ | 15.09 | 0.162 | |
| 3 | TiO₂ | 35.17 | 0.618 | |
| 2 | SiO₂ | 29.22 | 0.314 | |
| 1 | TiO₂ | 13.97 | 0.246 | |

Substrate side

| | |
|---|---|
| Total physical film thickness of high refractive index film HB (TiO₂ film) [nm] | 930.29 |
| Total physical film thickness of low refractive index film LB (SiO₂ film) [nm] | 1,346.87 |
| Ratio of physical film thickness HB/LB | 0.691 |

TABLE 6
Multilayer film: B2

| | | | |
|---|---|---|---|
| No. | Film material | Physical film thickness [nm] | QWOT |

Air side

| | | | | |
|---|---|---|---|---|
| 16 | SiO₂ | 117.36 | 1.263 | |
| 15 | TiO₂ | 12.56 | 0.221 | |
| 14 | SiO₂ | 239.47 | 2.577 | LB1 |
| 13 | TiO₂ | 12.66 | 0.223 | MB1 |
| 12 | SiO₂ | 81.36 | 0.875 | |
| 11 | TiO₂ | 12.44 | 0.219 | |
| 10 | SiO₂ | 53.01 | 0.570 | |
| 9 | TiO₂ | 9.00 | 0.158 | |
| 8 | SiO₂ | 9.00 | 0.097 | |
| 7 | TiO₂ | 13.14 | 0.231 | |
| 6 | SiO₂ | 9.00 | 0.097 | |
| 5 | TiO₂ | 88.41 | 1.554 | HB1 |
| 4 | SiO₂ | 10.82 | 0.116 | |
| 3 | TiO₂ | 13.82 | 0.243 | |
| 2 | SiO₂ | 29.81 | 0.321 | |
| 1 | TiO₂ | 9.00 | 0.158 | |

Light-absorbing layer side

| | |
|---|---|
| Total physical film thickness of high refractive index film HB (TiO₂ film) [nm] | 171.03 |
| Total physical film thickness of low refractive index film LB (SiO₂ film) [nm] | 549.83 |
| Ratio of physical film thickness HB/LB | 0.311 |

TABLE 7
Multilayer film: B3

| | | | |
|---|---|---|---|
| No. | Film material | Physical film thickness [nm] | QWOT |

Air side

| | | | | |
|---|---|---|---|---|
| 16 | SiO₂ | 120.01 | 1.291 | |
| 15 | TiO₂ | 10.74 | 0.189 | |
| 14 | SiO₂ | 238.88 | 2.571 | LB1 |
| 13 | TiO₂ | 12.34 | 0.217 | MB1 |
| 12 | SiO₂ | 70.75 | 0.761 | |
| 11 | TiO₂ | 14.92 | 0.262 | |
| 10 | SiO₂ | 51.08 | 0.550 | |
| 9 | TiO₂ | 11.72 | 0.206 | |
| 8 | SiO₂ | 9.00 | 0.097 | |
| 7 | TiO₂ | 15.95 | 0.280 | |
| 6 | SiO₂ | 12.17 | 0.131 | |
| 5 | TiO₂ | 86.90 | 1.528 | HB1 |
| 4 | SiO₂ | 18.28 | 0.197 | |
| 3 | TiO₂ | 23.56 | 0.414 | |
| 2 | SiO₂ | 42.75 | 0.460 | |
| 1 | TiO₂ | 9.00 | 0.158 | |

Light-absorbing layer side

| | |
|---|---|
| Total physical film thickness of high refractive index film HB (TiO₂ film) [nm] | 185.13 |
| Total physical film thickness of low refractive index film LB (SiO₂ film) [nm] | 562.92 |
| Ratio of physical film thickness HB/LB | 0.329 |

TABLE 8
Multilayer film: C1

| | | | | |
|---|---|---|---|---|
| | | Physical film thickness | | |
| No. | Film material | [nm] | QWOT | Total QWOT |

Air side

| | | | | | |
|---|---|---|---|---|---|
| 40 | SiO₂ | 103.51 | 1.114 | | |
| 39 | TiO₂ | 25.87 | 0.455 | | |
| 38 | SiO₂ | 63.17 | 0.680 | | |
| 37 | TiO₂ | 16.40 | 0.288 | | |
| 36 | SiO₂ | 59.78 | 0.643 | | |
| 35 | TiO₂ | 94.79 | 1.667 | | |
| 34 | SiO₂ | 14.65 | 0.158 | | |
| 33 | TiO₂ | 11.32 | 0.199 | | |
| 32 | SiO₂ | 85.70 | 0.922 | | |
| 31 | TiO₂ | 11.76 | 0.207 | | |
| 30 | SiO₂ | 24.68 | 0.266 | | |
| 29 | TiO₂ | 79.14 | 1.391 | HC2 | |
| 28 | SiO₂ | 160.43 | 1.726 | LC2 | |
| 27 | TiO₂ | 74.61 | 1.312 | HC2 | |
| 26 | SiO₂ | 9.00 | 0.097 | MC1 | 0.255 |
| 25 | TiO₂ | 9.00 | 0.158 | | |
| 24 | SiO₂ | 142.75 | 1.536 | LC1 | |
| 23 | TiO₂ | 89.20 | 1.568 | HC1 | |
| 22 | SiO₂ | 142.91 | 1.538 | LC1 | |
| 21 | TiO₂ | 9.00 | 0.158 | MC1 | 0.255 |
| 20 | SiO₂ | 9.00 | 0.097 | | |
| 19 | TiO₂ | 74.77 | 1.315 | HC2 | |
| 18 | SiO₂ | 159.11 | 1.712 | LC2 | |
| 17 | TiO₂ | 77.55 | 1.364 | HC2 | |
| 16 | SiO₂ | 18.65 | 0.201 | | |
| 15 | TiO₂ | 9.00 | 0.158 | | |
| 14 | SiO₂ | 115.42 | 1.242 | | |
| 13 | TiO₂ | 9.00 | 0.158 | | |
| 12 | SiO₂ | 9.00 | 0.097 | | |
| 11 | TiO₂ | 88.94 | 1.564 | | |
| 10 | SiO₂ | 78.26 | 0.842 | | |
| 9 | TiO₂ | 10.68 | 0.188 | | |
| 8 | SiO₂ | 46.89 | 0.505 | | |
| 7 | TiO₂ | 86.02 | 1.512 | | |
| 6 | SiO₂ | 26.26 | 0.283 | | |
| 5 | TiO₂ | 25.95 | 0.456 | | |
| 4 | SiO₂ | 39.28 | 0.423 | | |
| 3 | TiO₂ | 117.24 | 2.061 | | |
| 2 | SiO₂ | 38.42 | 0.413 | | |
| 1 | TiO₂ | 10.05 | 0.177 | | |

Light-absorbing layer side

| | |
|---|---|
| Total physical film thickness of high refractive index film HC (TiO₂ film) [nm] | 930.29 |
| Total physical film thickness of low refractive index film LC (SiO₂ film) [nm] | 1,346.87 |
| Ratio of physical film thickness IIC/LC | 0.691 |
| Total QWOT of high refractive index film HC (TiO₂ film) | 16.36 |
| Total QWOT of low refractive index film LC (SiO₂ film) | 14.49 |
| Ratio of QWOT HC/LC | 1.129 |

TABLE 9
Multilayer film: C2

| | | | | |
|---|---|---|---|---|
| | | Physical film thickness | | |
| No. | Film material | [nm] | QWOT | Total QWOT |

Light-absorbing layer side

| | | | | | |
|---|---|---|---|---|---|
| 41 | TiO₂ | 8.95 | 0.157 | | |
| 40 | SiO₂ | 29.81 | 0.321 | | |
| 39 | TiO₂ | 109.69 | 1.929 | HC3 | |
| 38 | SiO₂ | 55.37 | 0.596 | MC3 | 1.505 |
| 37 | TiO₂ | 16.49 | 0.290 | | |
| 36 | SiO₂ | 57.59 | 0.620 | | |
| 35 | TiO₂ | 46.15 | 0.811 | HC3 | |
| 34 | SiO₂ | 28.05 | 0.302 | MC2 | 0.683 |
| 33 | TiO₂ | 21.69 | 0.381 | | |
| 32 | SiO₂ | 108.17 | 1.164 | LC3 | |
| 31 | TiO₂ | 12.61 | 0.222 | MC2 | 0.426 |
| 30 | SiO₂ | 18.98 | 0.204 | | |
| 29 | TiO₂ | 79.74 | 1.402 | HC2 | |
| 28 | SiO₂ | 162.42 | 1.748 | LC2 | |
| 27 | TiO₂ | 75.46 | 1.327 | HC2 | |
| 26 | SiO₂ | 9.00 | 0.097 | MC1 | 0.255 |
| 25 | TiO₂ | 9.00 | 0.158 | | |
| 24 | SiO₂ | 142.64 | 1.535 | LC1 | |
| 23 | TiO₂ | 89.04 | 1.566 | HC1 | |
| 22 | SiO₂ | 141.82 | 1.526 | LC1 | |
| 21 | TiO₂ | 9.00 | 0.158 | MC1 | 0.255 |
| 20 | SiO₂ | 9.00 | 0.097 | | |
| 19 | TiO₂ | 74.56 | 1.311 | HC2 | |
| 18 | SiO₂ | 158.30 | 1.703 | LC2 | |
| 17 | TiO₂ | 77.59 | 1.364 | HC2 | |
| 16 | SiO₂ | 10.28 | 0.111 | MC2 | 0.269 |
| 15 | TiO₂ | 9.00 | 0.158 | | |
| 14 | SiO₂ | 132.62 | 1.427 | LC3 | |
| 13 | TiO₂ | 9.00 | 0.158 | MC2 | 0.255 |
| 12 | SiO₂ | 9.00 | 0.097 | | |
| 11 | TiO₂ | 86.24 | 1.516 | HC3 | |
| 10 | SiO₂ | 50.38 | 0.542 | MC3 | 1.304 |
| 9 | TiO₂ | 14.49 | 0.255 | | |
| 8 | SiO₂ | 47.13 | 0.507 | | |
| 7 | TiO₂ | 105.84 | 1.861 | HC3 | |
| 6 | SiO₂ | 36.62 | 0.394 | | |
| 5 | TiO₂ | 22.91 | 0.403 | | |
| 4 | SiO₂ | 33.74 | 0.363 | | |
| 3 | TiO₂ | 108.71 | 1.911 | | |
| 2 | SiO₂ | 17.37 | 0.187 | | |
| 1 | TiO₂ | 10.73 | 0.189 | | |

Substrate side

| | |
|---|---|
| Total physical film thickness of high refractive index film HC (TiO₂ film) [nm] | 930.29 |
| Total physical film thickness of low refractive index film LC (SiO₂ film) [nm] | 1,346.87 |
| Ratio of physical film thickness HC/LC | 0.691 |
| Total QWOT of high refractive index film HC (TiO₂ film) | 17.53 |
| Total QWOT of low refractive index film LC (SiO₂ film) | 13.54 |
| Ratio of QWOT HC/LC | 1.295 |

TABLE 10
Multilayer film: C3

| | | | | |
|---|---|---|---|---|
| | | Physical film thickness | | |
| No. | Film material | [nm] | QWOT | Total QWOT |

Substrate side

| | | | | | |
|---|---|---|---|---|---|
| 1 | TiO₂ | 10.58 | 0.186 | | |
| 2 | SiO₂ | 16.79 | 0.181 | | |
| 3 | TiO₂ | 106.08 | 1.865 | | |
| 4 | SiO₂ | 33.13 | 0.357 | | |
| 5 | TiO₂ | 22.52 | 0.396 | | |
| 6 | SiO₂ | 38.35 | 0.413 | | |
| 7 | TiO₂ | 106.02 | 1.864 | HC3 | |
| 8 | SiO₂ | 52.20 | 0.562 | MC3 | 1.368 |
| 9 | TiO₂ | 12.48 | 0.219 | | |
| 10 | SiO₂ | 54.58 | 0.587 | | |
| 11 | TiO₂ | 85.35 | 1.501 | HC3 | |
| 12 | SiO₂ | 9.00 | 0.097 | MC2 | 0.256 |
| 13 | TiO₂ | 9.08 | 0.160 | | |
| 14 | SiO₂ | 125.07 | 1.346 | LC3 | |
| 15 | TiO₂ | 9.00 | 0.158 | MC2 | 0.308 |
| 16 | SiO₂ | 13.89 | 0.149 | | |
| 17 | TiO₂ | 75.85 | 1.334 | HC2 | |
| 18 | SiO₂ | 159.38 | 1.715 | LC2 | |
| 19 | TiO₂ | 76.24 | 1.340 | HC2 | |
| 20 | SiO₂ | 9.00 | 0.097 | MC1 | 0.255 |
| 21 | TiO₂ | 9.00 | 0.158 | | |
| 22 | SiO₂ | 143.25 | 1.541 | LC1 | |
| 23 | TiO₂ | 90.27 | 1.587 | HC1 | |
| 24 | SiO₂ | 136.74 | 1.471 | LC1 | |
| 25 | TiO₂ | 9.72 | 0.171 | MC1 | 0.301 |
| 26 | SiO₂ | 12.10 | 0.130 | | |
| 27 | TiO₂ | 71.78 | 1.262 | HC2 | |
| 28 | SiO₂ | 158.98 | 1.711 | LC2 | |
| 29 | TiO₂ | 78.99 | 1.389 | HC2 | |
| 30 | SiO₂ | 9.00 | 0.097 | MC2 | 0.255 |
| 31 | TiO₂ | 9.00 | 0.158 | | |
| 32 | SiO₂ | 145.71 | 1.568 | LC3 | |
| 33 | TiO₂ | 17.59 | 0.309 | MC2 | 0.406 |
| 34 | SiO₂ | 9.00 | 0.097 | | |
| 35 | TiO₂ | 71.79 | 1.262 | HC3 | |
| 36 | SiO₂ | 15.86 | 0.171 | MC3 | 0.858 |
| 37 | TiO₂ | 24.81 | 0.436 | | |
| 38 | SiO₂ | 23.34 | 0.251 | | |
| 39 | TiO₂ | 104.83 | 1.843 | HC3 | |
| 40 | SiO₂ | 84.01 | 0.904 | | |

Air side

| | |
|---|---|
| Total physical film thickness of high refractive index film HC (TiO₂ film) [nm] | 1,000.98 |
| Total physical film thickness of low refractive index film LC (SiO₂ film) [nm] | 1,249.38 |
| Ratio of physical film thickness IIC/LC | 0.801 |
| Total QWOT of high refractive index film HC (TiO₂ film) | 17.60 |
| Total QWOT of low refractive index film LC (SiO₂ film) | 13.44 |
| Ratio of QWOT HC/LC | 1.309 |

With respect to the respective optical filters obtained as described above, spectral transmittance curves at an incident angle of 0 degrees and spectral reflectance curves at an incident angle of 5 degrees and an incident angle of 40 degrees in a wavelength range of 350 nm to 1,200 nm were measured using an ultraviolet-visible spectrophotometer.

Respective characteristics shown in the following Table 12 were calculated based on the obtained data of the spectral characteristics.

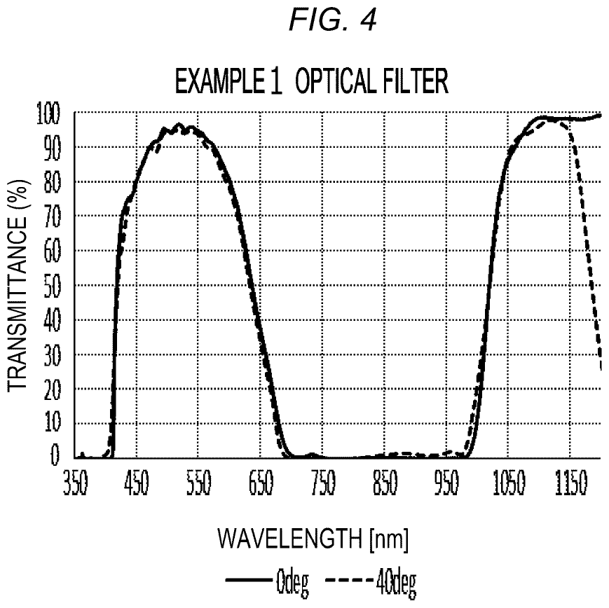

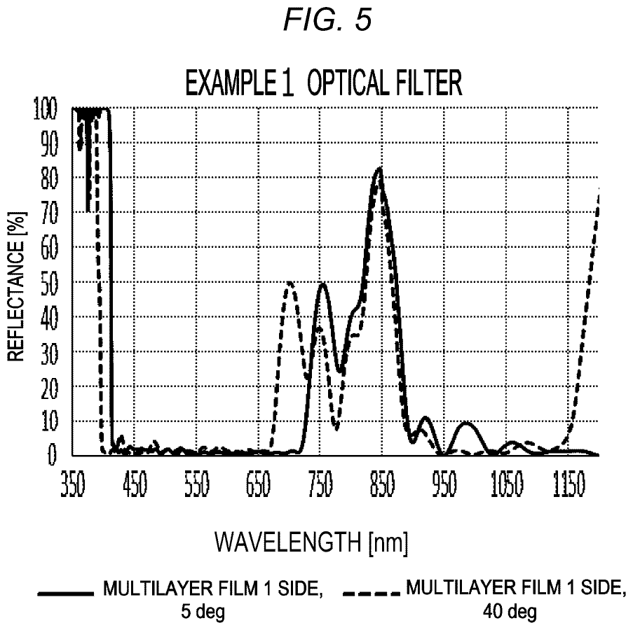

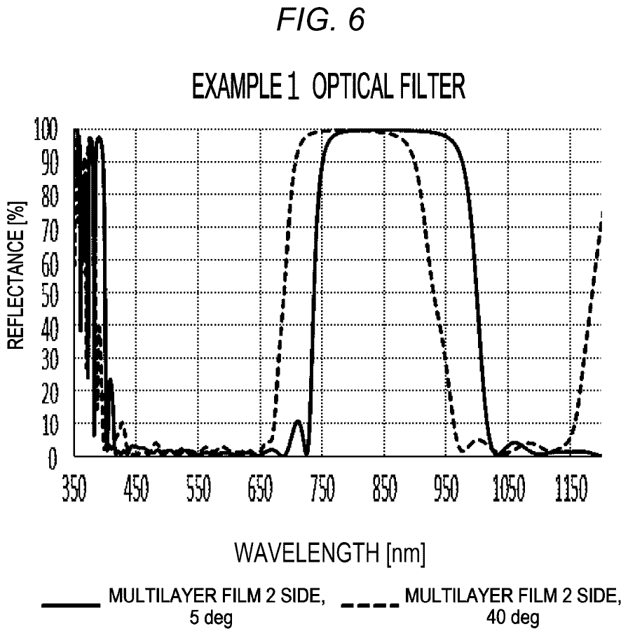

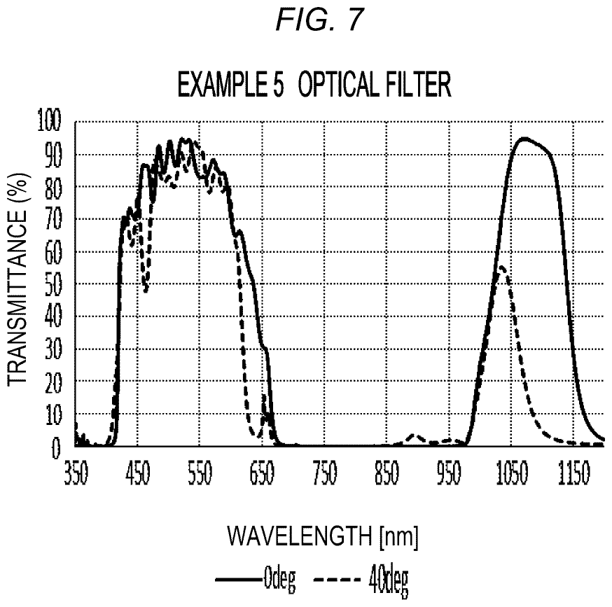

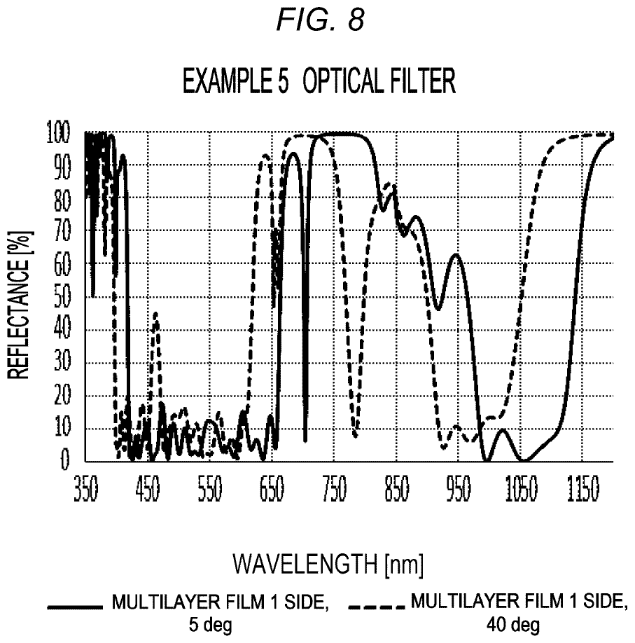

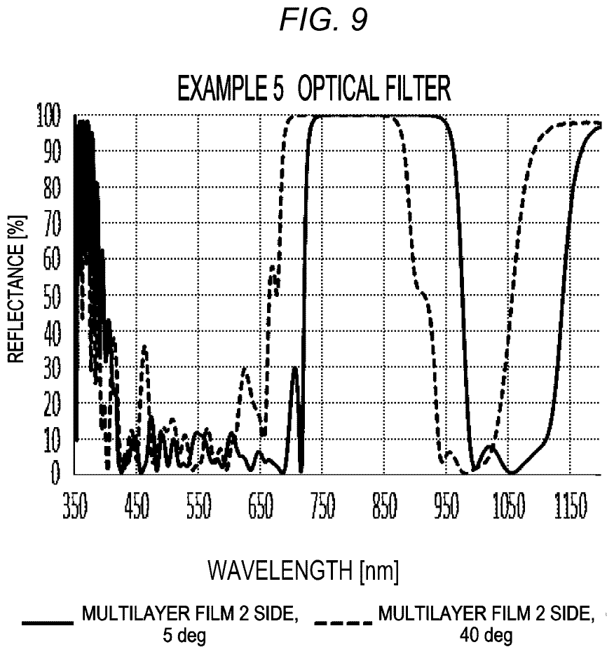

In addition, curves of spectral transmittance and reflectance of the respective optical filters of Examples 1 and 5 are shown in FIGS. 4 to 9, respectively.

Examples 1 to 4 are inventive examples, and Examples 5 and 6 are comparative examples.

TABLE 11

| | | Example 1 | Example 2 | Example 3 | Example 4 | Example 5 | Example 6 |
|---|---|---|---|---|---|---|---|
| Dielectric multilayer film | Type of multilayer film | C1 | B2 | B3 | C1 | X3 | Y3 |
| 3 | Film material | TiO₂/SiO₂ | TiO₂/SiO₂ | TiO₂/SiO₂ | TiO₂/SiO₂ | TiO₂/SiO₂ | TiO₂/SiO₂ |
| | Number of laminated layers | 40 | 16 | 16 | 40 | 30 | 8 |
| | Physical film thickness [nm] | 2,277.16 | 720.86 | 748.05 | 2,277.16 | 3,138.67 | 346.43 |
| Light-absorbing layer | Type of resin | Polyimide | Polyimide | Polyimide | Polyimide | Polyimide | Polyimide |
| | NIR dye | 3 types | 3 types | 3 types | 3 types | 3 types | 3 types |
| | Physical film thickness [nm] | 1,400 | 1,400 | 1,400 | 1,400 | 1,400 | 1,400 |
| Dielectric multilayer film | Type of multilayer film | B1 | C2 | A3 | B1 | X2 | — |
| 2 | Film material | TiO₂/SiO₂ | TiO₂/SiO₂ | TiO₂/SiO₂ | TiO₂/SiO₂ | TiO₂/SiO₂ | |
| | Number of laminated layers | 17 | 41 | 61 | 17 | 17 | |
| | Physical film thickness [nm] | 718.79 | 2,255.18 | 4,120.69 | 718.79 | 718.79 | |
| Glass substrate | Type | Glass A | Glass A | Glass A | Glass B | Glass A | Glass A |
| | Sheet thickness [mm] | 0.56 | 0.56 | 0.56 | 0.56 | 0.56 | 0.56 |
| Dielectric multilayer film | Type of multilayer film | A1 | A2 | C3 | A1 | X1 | Y1 |
| 1 | Film material | TiO₂/SiO₂ | TiO₂/SiO₂ | TiO₂/SiO₂ | TiO₂/SiO₂ | TiO₂/SiO₂ | TiO₂/SiO₂ |
| | Number of laminated layers | 60 | 60 | 40 | 60 | 22 | 8 |
| | Physical film thickness [nm] | 4,096.08 | 4,147.77 | 2,250.36 | 4,096.18 | 3,913.68 | 346.43 |

TABLE 12

| | Wavelength | Plane of | | | Transmittance/ | | | | | | |
|---|---|---|---|---|---|---|---|---|---|---|---|
| | range | incidence | | | reflectance | | Example | Example | Example | Example | Example |
| | [nm] | of light | Incident angle | | [%] | Example 1 | 2 | 3 | 4 | 5 | 6 |
| Optical filter | 1,300 to | Multilayer | 5 | degrees | Average | 98.17 | 97.39 | 95.09 | 97.99 | 81.44 | 24.20 |
| spectral | 1,500 | film | | | reflectance | | | | | | |
| characteristics | | 1 side | | | | | | | | | |
| | 1,300 to | Multilayer | 5 | degrees | Maximum | 99.69 | 99.61 | 99.53 | 99.73 | 99.52 | 25.37 |
| | 1,500 | film | | | reflectance | | | | | | |
| | | 1 side | | | | | | | | | |
| | 1,300 to | Multilayer | 40 | degrees | Average | 98.99 | 98.79 | 98.42 | 99.11 | 67.43 | 24.27 |
| | 1,500 | film | | | reflectance | | | | | | |
| | | 1 side | | | | | | | | | |
| | 1,300 to | Multilayer | 40 | degrees | Maximum | 99.50 | 99.40 | 99.31 | 99.55 | 91.00 | 26.94 |
| | 1,500 | film | | | reflectance | | | | | | |
| | | 1 side | | | | | | | | | |
| | 750 to 900 | Multilayer | 5 | degrees | Average | 98.99 | 53.81 | 38.02 | 99.00 | 99.97 | 1.12 |
| | | film | | | reflectance | | | | | | |
| | | 3 side | | | | | | | | | |
| | 750 to 900 | Multilayer | 5 | degrees | Maximum | 99.78 | 98.93 | 84.78 | 99.75 | 99.99 | 2.08 |
| | | film | | | reflectance | | | | | | |
| | | 3 side | | | | | | | | | |
| | 750 to 900 | Multilayer | 40 | degrees | Average | 98.38 | 60.05 | 38.71 | 98.41 | 96.08 | 1.78 |
| | | film | | | reflectance | | | | | | |
| | | 3 side | | | | | | | | | |
| | 750 to 900 | Multilayer | 40 | degrees | Maximum | 99.62 | 96.58 | 77.53 | 99.62 | 99.98 | 3.10 |
| | | film | | | reflectance | | | | | | |
| | | 3 side | | | | | | | | | |
| | 350 to 400 | — | 0 | degrees | Average | 0.01 | 0.01 | 0.01 | 0.01 | 0.19 | 10.50 |
| | | | | | transmittance | | | | | | |
| | 350 to 400 | — | 0 | degrees | Maximum | 0.12 | 0.14 | 0.05 | 0.15 | 2.55 | 52.32 |
| | | | | | transmittance | | | | | | |
| | 350 to 400 | — | 40 | degrees | Average | 0.21 | 0.17 | 0.16 | 0.21 | 0.50 | 8.81 |
| | | | | | transmittance | | | | | | |
| | 350 to 400 | — | 40 | degrees | Maximum | 1.87 | 0.99 | 1.00 | 1.91 | 6.94 | 51.98 |
| | | | | | transmittance | | | | | | |
| | 430 to | Multilayer | | | Total of | 31,414 | 25,366 | 13,874 | 17,174 | 15,084 | 32,505 |
| | 1,100 | film | | | absorption | | | | | | |
| | | 3 side | | | characteristics | | | | | | |
| | 420 to 650 | Multilayer | 5 | degrees | Average | 1.18 | 0.95 | 1.63 | 2.73 | 6.71 | 2.85 |
| | | film | | | reflectance | | | | | | |
| | | 1 side | | | | | | | | | |
| | 420 to 650 | Multilayer | 5 | degrees | Maximum | 2.73 | 1.65 | 4.33 | 6.96 | 17.56 | 6.45 |
| | | film | | | reflectance | | | | | | |
| | | 1 side | | | | | | | | | |
| | 420 to 650 | Multilayer | 40 | degrees | Average | 1.88 | 1.17 | 2.56 | 3.75 | 21.63 | 3.31 |
| | | film | | | reflectance | | | | | | |
| | | 1 side | | | | | | | | | |
| | 420 to 650 | Multilayer | 40 | degrees | Maximum | 6.29 | 3.25 | 10.52 | 11.05 | 92.94 | 5.56 |
| | | film | | | reflectance | | | | | | |
| | | 1 side | | | | | | | | | |
| | 1,030 to | Multilayer | 5 | degrees | Average | 1.79 | 1.61 | 3.11 | 4.12 | 14.46 | 9.96 |
| | 1,150 | film | | | reflectance | | | | | | |
| | | 1 side | | | | | | | | | |
| | 1,030 to | Multilayer | 5 | degrees | Maximum | 3.91 | 2.55 | 5.91 | 5.17 | 73.26 | 11.71 |
| | 1,150 | film | | | reflectance | | | | | | |
| | | 1 side | | | | | | | | | |
| | 1,030 to | Multilayer | 40 | degrees | Average | 2.50 | 1.85 | 3.70 | 4.63 | 78.46 | 12.15 |
| | 1,150 | film | | | reflectance | | | | | | |
| | | 1 side | | | | | | | | | |
| | 1,030 to | Multilayer | 40 | degrees | Maximum | 5.69 | 4.19 | 9.87 | 6.68 | 98.94 | 16.35 |
| | 1,150 | film | | | reflectance | | | | | | |
| | | 1 side | | | | | | | | | |
| | 420 to 650 | Multilayer | 5 | degrees | Average | 1.17 | 1.56 | 1.58 | 2.30 | 5.96 | 2.36 |
| | | film | | | reflectance | | | | | | |
| | | 3 side | | | | | | | | | |
| | 420 to 650 | Multilayer | 5 | degrees | Maximum | 3.25 | 3.08 | 3.32 | 6.79 | 16.07 | 5.85 |
| | | film | | | reflectance | | | | | | |
| | | 3 side | | | | | | | | | |
| | 420 to 650 | Multilayer | 40 | degrees | Average | 2.11 | 2.06 | 2.27 | 3.43 | 11.55 | 2.74 |
| | | film | | | reflectance | | | | | | |
| | | 3 side | | | | | | | | | |
| | 420 to 650 | Multilayer | 40 | degrees | Maximum | 10.31 | 5.89 | 5.56 | 13.99 | 35.76 | 4.93 |
| | | film | | | reflectance | | | | | | |
| | | 3 side | | | | | | | | | |
| | 1,030 to | Multilayer | 5 | degrees | Average | 1.85 | 1.84 | 3.24 | 4.10 | 14.46 | 9.84 |
| | 1,150 | film | | | reflectance | | | | | | |
| | | 3 side | | | | | | | | | |
| | 1,030 to | Multilayer | 5 | degrees | Maximum | 4.19 | 5.01 | 6.07 | 5.16 | 73.26 | 11.68 |
| | 1,150 | film | | | reflectance | | | | | | |
| | | 3 side | | | | | | | | | |
| | 1,030 to | Multilayer | 40 | degrees | Average | 2.53 | 2.08 | 3.71 | 4.62 | 74.10 | 11.89 |
| | 1,150 | film | | | reflectance | | | | | | |
| | | 3 side | | | | | | | | | |
| | 1,030 to | Multilayer | 40 | degrees | Maximum | 5.72 | 4.82 | 9.82 | 6.69 | 97.65 | 16.32 |
| | 1,150 | film | | | reflectance | | | | | | |
| | | 3 side | | | | | | | | | |

From the above results, it is understood that any of the optical filters of Examples 1 to 4 including the dielectric multilayer films 1 to 3 is excellent in reflection characteristics of light having a wavelength of 1,300 nm to 1,500 nm and light having a wavelength of 750 nm to 900 nm even at a high incident angle, and is excellent in shielding properties of light having a wavelength of 350 nm to 400 nm.

On the other hand, in the optical filter of Example 5 which does not include the dielectric multilayer films 1 and 3 satisfying a predetermined requirement, the reflection characteristics of the light having a wavelength of 1,300 nm to 1,500 nm were small, and the shielding properties of the light having a wavelength of 350 nm to 400 nm was also insufficient.

In addition, in the optical filter of Example 6 which does not include the dielectric multilayer film 2, both the reflection characteristics of the light having a wavelength of 1,300 nm to 1,500 nm and the light having a wavelength of 750 nm to 900 nm and the shielding properties of the light having a wavelength of 350 nm to 400 nm were insufficient.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2023-210429) filed on Dec. 13, 2023, the content of which is incorporated herein by reference.

### INDUSTRIAL APPLICABILITY

The optical filter according to the present embodiment is excellent in transmittance of visible light and specific near-infrared light even at a high incident angle, and is excellent in shielding properties of other near-infrared light. The optical filter is useful for applications of imaging devices such as cameras and sensors for transport machines, for which high performance has been achieved in recent years.

What is claimed is:

1. An optical filter comprising:
a dielectric multilayer film 1;
a glass substrate;
a dielectric multilayer film 2;
a light-absorbing layer; and
a dielectric multilayer film 3 in this order, wherein
the light-absorbing layer comprises a near-infrared ray absorbing dye, and
the optical filter satisfies all of the following spectral characteristics (i-1) to (i-6):
(i-1) an average reflectance of a light having a wavelength of 1,300 nm to 1,500 nm when the light is incident from one main surface of the optical filter is 90% or more at an incident angle of 5 degrees and 90% or more at an incident angle of 40 degrees,
(i-2) a maximum reflectance of the light having a wavelength of 1,300 nm to 1,500 nm when the light is incident from the one main surface is 95% or more at an incident angle of 5 degrees and 95% or more at an incident angle of 40 degrees,
(i-3) an average reflectance of a light having a wavelength of 750 nm to 900 nm when the light is incident from the other main surface of the optical filter is 30% or more at an incident angle of 5 degrees and 30% or more at an incident angle of 40 degrees,
(i-4) a maximum reflectance of the light having a wavelength of 750 nm to 900 nm when the light is incident from the other main surface is 80% or more at an incident angle of 5 degrees and 70% or more at an incident angle of 40 degrees,
(i-5) an average transmittance of a light having a wavelength of 350 nm to 400 nm is 1% or less at an incident angle of 0 degrees and 2% or less at an incident angle of 40 degrees, and
(i-6) a maximum transmittance of the light having a wavelength of 350 nm to 400 nm is 2% or less at an incident angle of 0 degrees and 3% or less at an incident angle of 40 degrees.

2. The optical filter according to claim 1, wherein at least one of the dielectric multilayer films 1 to 3 satisfies all of the following characteristics (iiB-1) to (iiB-3):
(iiB-1) a total number of laminated layers is 1 to 60,
(iiB-2) a high refractive index layer HB having a refractive index of 1.8 or more and 2.5 or less and a low refractive index layer LB having a refractive index of 1.4 or more and 1.6 or less are provided, and a ratio of a total physical film thickness of the high refractive index layer HB to a total physical film thickness of the low refractive index layer LB is 0.2 to 0.8, and
(iiB-3) when a high refractive index layer having a QWOT of 1.0 or more is defined as an HB₁ layer among the high refractive index layer HB and the low refractive index layer having a QWOT of 1.0 or more is defined as an LB₁ layer among the low refractive index layer LB,
a layer between the HB₁ layer and the LB₁ layer is an MB₁ layer comprising a single layer or a plurality of layers and having a QWOT of 1.0 or less per one layer of all the layers, and
one or more laminated structures represented by the following formula is provided: (HB₁ layer/MB₁ layer/LB₁ layer).

3. The optical filter according to claim 1, wherein at least one of the dielectric multilayer films 1 to 3 satisfies all of the following characteristics (iiA-1) to (iiA-3):
(iiA-1) a total number of laminated layers is 1 to 80,
(iiA-2) high refractive index layers HA having a refractive index of 1.8 or more and 2.5 or less and low refractive index layers LA having a refractive index of 1.4 or more and 1.6 or less are provided, and a ratio of a total physical film thickness of the high refractive index layers HA to a total physical film thickness of the low refractive index layers LA is 0.3 to 0.8, and
(iiA-3) when a layer having a QWOT of 1.0 or more and being n-th closest to the glass substrate among the high refractive index layers HA is defined as a HAₙ layer, and a layer having a QWOT of 1.0 or more and being next closest to the glass substrate with respect to the HAₙ layer among the low refractive index layers LA is defined as a LAₙ layer,
a layer between the HAₙ layer and the LAₙ layer is an MA₂ₙ₋₁ layer comprising a single layer or a plurality of layers and having a total QWOT of 1 or less,
a layer between the LAₙ layer and a HAₙ₊₁ layer having a QWOT of 1.0 or more and being (n+1)-th closest to the glass substrate is a MA₂ₙ layer comprising a single layer or a plurality of layers and having a total QWOT of 1 or less, and
a repeating structure represented by the following formula is provided where n is a natural number of 2 or more:
(HA₁ layer/MA₁ layer/LA₁ layer/MA₂ layer) . . . (HAₙ layer/MA₂ₙ₋₁ layer/LAₙ layer/MA₂ₙ layer).

4. The optical filter according to claim 1, wherein at least one of the dielectric multilayer films 1 to 3 satisfies all of the following characteristics (iiC-1) to (iiC-3):
(iiC-1) a total number of laminated layers is 1 to 60,
(iiC-2) a high refractive index layer HC having a refractive index of 1.8 or more and 2.5 or less and a low refractive index layer LC having a refractive index of 1.4 or more and 1.6 or less are provided, a ratio of a total physical film thickness of the high refractive index layer HC to a total physical film thickness of the low refractive index layer LC is 0.5 to 0.9, and a ratio of a total QWOT of the high refractive index layer HC to a total QWOT of the low refractive index layer LC is 1.1 to 1.5, and
(iiC-3) a laminated structure represented by the following formula is provided:
(HC₂ layer/LC₂ layer/HC₂ layer)/MC₁ layer/(LC₁ layer/HC₁ layer/LC₁ layer)/MC₁ layer/(HC₂ layer/LC₂ layer/HC₂ layer),
where the HC₁ layer and the HC₂ layers are each independently a high refractive index layer having a QWOT of 1.0 or more,
the LC₁ layers and the LC₂ layers are each independently a low refractive index layer having a QWOT of 1.0 or more, and
the MC₁ layers each independently comprise a single layer or a plurality of layers having a total QWOT of 1 or less.

5. The optical filter according to claim 1, wherein the glass substrate comprises ytterbium.

6. The optical filter according to claim 1, wherein the optical filter further satisfies the following spectral characteristic (i-7):
(i-7) an integral value of an (absorption loss amount) 430-1100 at a wavelength of 430 nm to 1,100 nm is 10,000 or more,
where, when a light is incident from either of the main surfaces, an (absorption loss amount)_{X} at a wavelength of X nm is defined as follows:
$$( absorption loss amount ) x [ \% ] = 100 - ( transmittance at incident angle of 0 degrees ) - ( reflectance at incident angle of 5 degrees ) .$$

7. The optical filter according to claim 1, wherein the glass substrate comprises, in terms of mol % based on an oxide:
0.1 mol % to 50 mol % of SiO₂;
15 mol % to 40 mol % of B₂O₃;
0 mol % to 15 mol % of P₂O₅; and
20 mol % to 60 mol % of Yb₂O₃.

8. The optical filter according to claim 1, wherein the near-infrared ray absorbing dye comprises a dye having a maximum absorption wavelength in a wavelength region of 680 nm to 800 nm, and
the light-absorbing layer satisfies both the following spectral characteristics (iii-1) and (iii-2):
(iii-1) when a shortest wavelength at which an internal transmittance is 30% in a spectral transmittance curve at a wavelength of 650 nm to 720 nm is defined as λL_{A_VIS(30%)}, and a shortest wavelength at which an internal transmittance is 30% in a spectral transmittance curve at a wavelength of 720 nm to 1,000 nm is defined as λ_{A_IR(30%)}, the following relational expression is satisfied:

|λ_{A_IR(30%)}−λ_{A_VIS(30%)}|≥100 nm, and
(iii-2) when an optical density at a wavelength of 720 nm is defined as OD_{_720}, the following relational expression is satisfied:
$${OD}_{\_ 720} \geq 2. .$$

9. The optical filter according to claim 1, wherein the optical filter satisfies all of the following spectral characteristics (i-8) to (i-11):
(i-8) an average reflectance of a light having a wavelength of 420 nm to 650 nm when the light is incident from the one main surface is 5% or less at an incident angle of 5 degrees and 5% or less at an incident angle of 40 degrees,
(i-9) a maximum reflectance of the light having a wavelength of 420 nm to 650 nm when the light is incident from the one main surface is 10% or less at an incident angle of 5 degrees and 15% or less at an incident angle of 40 degrees,
(i-10) an average reflectance of a light having a wavelength of 1,030 nm to 1,150 nm when the light is incident from the one main surface is 9% or less at an incident angle of 5 degrees and 10% or less at an incident angle of 40 degrees, and
(i-11) a maximum reflectance of the light having a wavelength of 1,030 nm to 1,150 nm when the light is incident from the one main surface is 10% or less at an incident angle of 5 degrees and 15% or less at an incident angle of 40 degrees.

10. The optical filter according to claim 1, wherein the optical filter satisfies all of the following spectral characteristics (i-12) to (i-15):
(i-12) an average reflectance of a light having a wavelength of 420 nm to 650 nm when the light is incident from the other main surface is 5% or less at an incident angle of 5 degrees and 5% or less at an incident angle of 40 degrees,
(i-13) a maximum reflectance of the light having a wavelength of 420 nm to 650 nm when the light is incident from the other main surface is 10% or less at an incident angle of 5 degrees and 15% or less at an incident angle of 40 degrees,
(i-14) an average reflectance of a light having a wavelength of 1,030 nm to 1,150 nm when the light is incident from the other main surface is 9% or less at an incident angle of 5 degrees and 10% or less at an incident angle of 40 degrees, and
(i-15) a maximum reflectance of the light having a wavelength of 1,030 nm to 1,150 nm when the light is incident from the other main surface is 10% or less at an incident angle of 5 degrees and 15% or less at an incident angle of 40 degrees.

11. An imaging device comprising the optical filter according to claim 1.
